(19) United States
(12) Patent Application Publication
(10) Pub. No.: US 2011/0027549 A1
(43) Pub. Date: Feb. 3, 2011

(54) METHOD AND APPARATUS FOR EMBEDDING ABRASIVE PARTICLES INTO SUBSTRATES

(76) Inventor: Zine-Eddine Boutaghou, North Oaks, MN (US)

Correspondence Address: Clise, Billion & Cyr, P.A., 605 U.S. Highway 169, Suite 300, Plymouth, MN, 55441, US

(21) Appl. No.: 12/751,586

(22) Filed: Mar. 31, 2010

Related U.S. Application Data
(60) Provisional application No. 61/220,149, filed on Jun. 24, 2009.
(60) Provisional application No. 61/232,425, filed on Aug. 8, 2009.

(51) Int. Cl. B24D 3/00; B32B 5/16; B30B 15/06

(52) U.S. Cl. 428/206; 428/323; 100/295

(57) ABSTRACT

A dressing bars for embedding abrasive particles into a substrate at a substantially uniform height. Spacing pads, hydrostatic and/or hydrodynamic fluid bearing (air is the typical fluid) maintains a constant spacing and attitude between the dressing bar and the substrate. The fluid bearing permits the dressing bar to maintain a desirable stiffness between the lapping plate and the dressing bar. The bar geometry and fluid bearing design permits the bar to mitigate or compensate for the micrometer-scale and/or millimeter-scale wavelengths of waviness on the substrate, while maintaining a substantially constant clearance to uniformly embed the abrasive particle into the substrate.

### CROSS-REFERENCE TO RELATED APPLICATIONS

This application claims the benefit of the filing date of U.S. Provisional Patent Application Ser. No. 60/220,149 filed Jun. 24, 2009, which is entitled “Constant Clearance Plate for Embedding Diamonds into Lapping Plates” which is hereby incorporated herein in its entirety by reference.

### FIELD OF THE INVENTION

The present invention is directed to a dressing bar for embedding abrasive particles into a substrate at a substantially uniform height. Spacing pads, hydrostatic and/or hydrodynamic fluid bearing (air is the typical fluid) maintains a constant spacing and attitude between the dressing bar and the substrate. The fluid bearing permits the dressing bar to maintain a desirable stiffness between the lapping plate and the dressing bar. The bar geometry and fluid bearing design permits the bar to mitigate or compensate for the micrometer-scale and/or millimeter-scale wavelengths of waviness on the substrate, while maintaining a substantially constant clearance to uniformly embed the abrasive particle into the substrate.

### BACKGROUND OF THE INVENTION

Read-write heads for disk drives are formed at the wafer level using a variety of deposition and photolithographic techniques. Multiple sliders, up to as many as 40,000, may be formed on one wafer. The wafer is then sliced into slider bars, each having up to 60-70 sliders. The slider bars are lapped to polish the surface that will eventually become the air bearing surface. A carbon overcoat is then applied to the slider bars. Finally, individual sliders are sliced from the bar and mounted on gimbal assemblies for use in disk drives.

Slider bars are currently lapped using a tin plate charged with small diamonds having an average diameter of about 150 nm or less. FIG. 1A illustrates a conventional tin substrate 20 charged with diamonds 22. The diamonds 22 are embedded below surface 24 of the tin plate. The final height 26 of the diamonds 22 embedded in the surface 24 of the charged substrate 20 are not uniform. The height variation in the diamonds 22 embedded in the surface can be 1 to 5 percent of the mean height of the embedded diamonds. The height variation of the diamonds 22 on top of surface 24 create non uniform stress during the lapping process. Such non uniform stress due to variable diamond height 26 causes scratches and damage to the bar.

A conventional tin substrate is prepared in several steps. The first step is to machine a flat tin plate. The second step is to machine grooves or geometrical features that promote lubricant circulation and control the thickness of the hydrodynamic film between the oil lubricant and the slider bars.

The third step is to charge the tin plate with diamonds, such as illustrated in U.S. Pat. No. 6,953,385 (Singh, Jr.). Singh teaches applying a ceramic impregnator downward on the substrate surface with a controlled force while the diamond slurry is supplied. The diamonds are impregnated into the relatively soft tin layer of the substrate.

Fourth, the impregnated substrate is dressed with a conventional dressing bar. The conventional dressing bar applies a uniform load by pressing the larger diamonds further into the tin, producing a more uniform applied load on the embedded diamonds which contributes to impregnating the diamonds into the plate. Several runs of the dressing bar are required to improve height uniformity of the abrasive diamonds impregnated into the tin.

FIG. 1B illustrates a conventional dressing bar 30. The outer edge 32 of the dressing bar 30 is designed with a sharp ninety-degree angle interfacing with the diamonds during the abrasive particles embedding process. The sharp outer edge 32 does not allow for efficient penetration of diamonds into the interface defined by the dressing bar and the substrate. This process generates a large amount of industrial waste. Current processes are wasteful since over 90 percent of the diamonds are lost and unrecoverable in the process.

During use, the substrate is flooded with a lubricant (oil or water based). The viscosity of oil-based lubricants is about 4 orders of magnitude greater than the viscosity of air. The lubricant causes a hydrodynamic film to be generated between the slider bar and the substrate. The hydrodynamic film is critical in establishing a stable interface during the lapping process and to reduce vibrations and chatter. To overcome the hydrodynamic film, a relatively large force is exerted onto the slider bar to cause interference with the diamonds necessary to promote polishing. A preload of about 10 kilograms is not uncommon to engage a single slider bar with the lapping media.

FIG. 2 is a schematic side sectional view of a conventional slider including the critical sensors including read and write elements. As used herein, “read-write transducer” refers to one or more of the return pole, the write pole, the read sensor, magnetic shields, and any other components that are spacing sensitive. Various methods and systems for finish lapping read-write transducers are disclosed in U.S. Pat. No. 5,386,666 (Cole); U.S. Pat. No. 5,632,669 (Azarian et al.); U.S. Pat. No. 5,885,131 (Azarian et al.); U.S. Pat. No. 6,568,992 (Angelo et al.); and U.S. Pat. No. 6,857,937 (Bajorek).

Variables such as lapping media speed, preload on the slider bar load, nominal diamond size, and lubricant type must be balanced to yield a desirable material removal rate and finish. A balance is also required between the hydrodynamic film and the height of the embedded diamonds to achieve an interference level between the slider bar and the diamonds.

The preload applied to the slider bar is typically determined by the density of the diamonds and the diamond height variation. As the industry moves to nano-diamonds, which are smaller than 150 nm, the preload will need to be increased to reduce the fluid film thickness a sufficient amount so the nano-diamonds contact the slider bar. Nano-diamonds are difficult to embed in the tin plate. This difficulty leads to free diamonds. The free diamonds increase the risk of damaging the slider bar.

Slider bars with trailing edges composed of metallic layers and ceramic layers present very severe challenges during lapping. Composite structures of hard and soft layers present differential lapping rates when lapped using conventional abrasive substrates. The variable polishing rates of the metallic and ceramic materials lead to severe recessions, sensor damage, and other problems. FIG. 3 illustrates the slider of FIG. 2 after lapping with a conventional diamond-charged substrate. The diamond-charged plates cause large transducer protrusion and recession variations, substrate recession, microscopic substrate fractures leading to particle release during operation of the disk drive, scratches leading to transducer damage.

The realization of high data density depends, in part, on designing a head-disk interface (HDI) with the smallest possible head-media spacing (“HMS”). Head-media spacing refers to the distance between a read or write sensor and a surface of a magnetic media.

U.S. Pat. Nos. 7,198,533 and 6,123,612 disclose an abrasive article including a plurality of abrasive particles securely affixed to a substrate with a corrosion resistant matrix material. The matrix material includes a sintered corrosion resistant powder and a brazing alloy. The brazing alloy includes an element which reacts with and forms a chemical bond with the abrasive particles, thereby securely holding the abrasive particles in place. A method of forming the abrasive article includes arranging the abrasive particles in the matrix material, and applying sufficient heat and pressure to the mixture of abrasive particles and matrix material to cause the corrosion resistant powder to sinter, the brazing alloy flows around, react with, and forms chemical bonds with the abrasive particles, and allows the brazing alloy to flow through the interstices of the sintered corrosion resistant powder and forms an inter-metallic compound therewith.

U.S. Pat. Publication No. 2009/0038234 (Yin) discloses a method for making a conditioning pad using a plastic substrate having a plurality of recesses. The abrasive grains are secured in the recesses by adhesive. The second substrate is formed around the exposed portions of the abrasive grains. After the second substrate hardens, the first substrate is removed, exposing the cutting surfaces of the abrasive grains.

Example 1 of Yin teaches recesses are about 225 micrometers deep and about 450 micrometers wide, with a maximum height difference between the highest and lowest peak of about 25 micrometers. Example 3 of Yin discloses a maximum height difference between the highest and lowest peak of about 15 micrometers. Yin discloses diamond abrasive grains with particle diameters ranging from 10 mesh to 140 mesh. Applicants believe these mesh sizes correspond generally to abrasive particles with a major diameter of about 2 millimeters to about 0.1 millimeters. The large size of the diamonds of Yin allows for insertion into the recesses. Forming the first substrate with sub-micron sized recesses and then inserting sub-micron sized abrasive grains, however, is not currently commercially viable. Sorting sub-micron sized abrasive grains is also problematic.

Other methods for orienting and positioning discrete abrasive particles are disclosed in U.S. Pat. No. 6,669,745 (Prichard et al.) and U.S. Pat. No. 6,769,975 (Sagawa), and U.S. Pat. Publication No. 2008/0053000 (Palmgren).

### BRIEF SUMMARY OF THE INVENTION

The present invention is directed a dressing bar for embedding abrasive particles into a substrate at a substantially uniform height. The present invention is also directed to an abrasive article with abrasive particles embedded in a substrate at a substantially uniform height, including a method of making and use the abrasive article. The abrasive article is typically nano-scale diamonds embedded in a tin lapping plate. The present method and abrasive article can be used with the current infrastructure for lapping and polishing.

A hydrodynamic and/or hydrostatic fluid bearing (in one embodiment, air is the fluid) is maintained between the dressing bar and the substrate. Another method includes maintaining spacing between the dressing bar and the tin plate using a set of pads constructed onto the bar with a height matching the spacing. The fluid bearing produces stiffness between the plate and the dressing bar, while maintaining a constant clearance, to uniformly embed the abrasive particle into the substrate. A high stiffness minimizes or substantially lessens the excursion of the bar during the dressing bar and diamond interaction. The excursion of the dressing bar embeds diamonds into the soft plate with a substantially uniform height. The fluid used to suspend the bar with a constant clearance can be gas, liquid, or a combination thereof. As used herein, “topography following” refers to a dressing bar that can generally be designed to follow the topography of the plate at a generally uniform clearance above a substrate to reduce nanometer-scale height variations of abrasive particles on the surface. Also used herein, “topography averaging” refers to a dressing designed to filter the effects of topography of the plate leading to an average clearance above a substrate suppressing the effects of nanometer-scale height variations of abrasive particles on the surface.

The dressing bar interfaces with a gimbal mechanism. A preload mechanism places a preload onto the dressing bar through the gimbal mechanism. The preload mechanism and the gimbal mechanism permit the dressing bar to move vertically, and in pitch and roll relative to the substrate respectively. The fluid bearing provides vertical stiffness, and pitch and roll stiffness to the dressing bar, while controlling the spacing and pressure distribution across the fluid bearing features of the dressing bar. The high stiffness of the dressing bar reduces clearance loss and chatter emanating from particle interaction during embedding of the abrasive particles. Adjustments to certain variables, such as for example, dressing bar fluid bearing configuration, fluid bearing characteristics, pitch and roll stiffness, and preload, can be made to control the dressing bar spacing, attitude and fluid bearing stiffness.

In hydrodynamic applications, fluid bearing surface geometries play a role in pressurization of fluid bearing surfaces, particularly on hydrodynamic fluid bearings. Possible geometries on the fluid bearing surface include tapers, steps, trenches, crowns, cross curves, twists, wall profile, and cavities. Finally, external factors such as viscosity of the bearing fluid and linear velocity play an extremely important role in pressurizing bearing structures.

In one embodiment, the spacing profile is achieved with a fluid bearing configured to achieve a pitch and roll stiffness capable of countering the forces emanating from the interaction between the abrasive particles and the dressing bar during the charging process. In another embodiment, the spacing profile is achieved with the aid of actuators causing the dressing bar to maintain a desired spacing profile with respect to the substrate. The present systems and methods can be used with or without lubricants.

In one embodiment, the dressing bar includes a leading edge taper causing progressive interference with the embedded abrasive particles. In a second embodiment, the interference with the abrasive particles is controlled by pitch of the dressing bar. The pitch of the dressing bar can be achieved with a hydrostatic clearance profile, or by appropriately controlling actuators acting on the dressing bar. Pads are optionally added to a tapered dressing bar to allow for a low frictional interface and a clearance setting between the dressing bar and the substrate.

Large forces are incurred during the process of embedding abrasives. The fluid bearing stiffness is designed to counter the cutting forces and moments resulting from the embedding process. The spacing control between the dressing bar and the substrate is crucial to controlling the height of the final embedded abrasives. Spacing control can be achieved by hydrostatic and/or hydrodynamic fluid bearings, with or without actuators.

The method of making an abrasive article in accordance with the present invention includes the steps of distributing a slurry, that includes abrasive particles, on a surface of a substrate. A dressing bar is connected to the support structure with a gimbal assembly. The gimbal assembly permits displacement of the dressing bar in at least pitch and roll. The dressing bar is biased toward the substrate to engage an active surface on the dressing bar with the slurry. A fluid bearing is generated between the dressing bar assembly and the substrate. The fluid bearing can be adjusted to control spacing between the dressing bar assembly and the substrate. The active surface of the dressing bar applies a compressive force sufficient to embed the abrasive particles into the surface.

The present method and apparatus permits the height of the abrasive particles relative to the substrate to be precisely controlled. Consequently, abrasive articles made using the present method and apparatus can be tailored for particular applications and process parameters, such as for example the customers preferred lubricant. In one embodiment, a first abrasive article is prepared for use with a first lubricant having a first viscosity and a second abrasive article is prepared for use with a second lubricant having a second viscosity different from the first viscosity.

### BRIEF DESCRIPTION OF THE SEVERAL VIEWS OF THE DRAWING

FIG. 1A is a schematic sectional view of a prior art diamond-charged substrate.

FIG. 1B is a perspective view of a prior art dressing bar.

FIG. 2 is a schematic side sectional view of a conventional slider bar before lapping.

FIG. 3 illustrates the bar of FIG. 2 after lapping with a conventional diamond-charged substrate.

FIG. 4A is a schematic illustration of a method and apparatus for progressively embedding abrasive particles, in accordance with an embodiment of the present invention.

FIG. 4B is a cross section of a plate with a substantially uniform abrasive embedded therein, in accordance with an embodiment of the present invention.

FIG. 4C is a probability distribution of the abrasive particle height, in accordance with an embodiment of the present invention.

FIG. 5 is a perspective view of a tapered dressing bar, in accordance with an embodiment of the present invention.

FIG. 6 is a perspective view of a circular tapered dressing bar, in accordance with an embodiment of the present invention.

FIG. 7A is a perspective view of a grooved and tapered dressing bar, in accordance with an embodiment of the present invention.

FIG. 7B is a perspective view of a lapping plate with substantially uniform abrasive height and spaced according to the groove to land ratio of the dressing bar shown in FIG. 7A, in accordance with an embodiment of the present invention.

FIG. 8 is a perspective view of an alternate grooved and tapered dressing bar, in accordance with an embodiment of the present invention.

FIG. 9 is a perspective view of a dressing bar with spacers, in accordance with an embodiment of the present invention.

FIG. 10 is a perspective view of a circular dressing bar with spacers, in accordance with an embodiment of the present invention.

FIG. 11 is an exploded view of a gimballed dressing bar holder, in accordance with an embodiment of the present invention.

FIG. 12 is a perspective side view of the gimballed dressing bar holder of FIG. 11, in accordance with an embodiment of the present invention.

FIGS. 13A and 13B illustrate the gimballed dressing bar holder of FIG. 11 before and after engagement with a substrate, in accordance with an embodiment of the present invention.

FIG. 14 is an exploded view of an alternate gimballed dressing bar holder, in accordance with an embodiment of the present invention.

FIG. 15 is a cross sectional view of the gimballed dressing bar holder of FIG. 14, as assembled in accordance with an embodiment of the present invention.

FIGS. 16 and 17 are perspective views of the gimballed dressing bar holder of FIG. 14, in accordance with an embodiment of the present invention.

FIG. 18 is a perspective view of a gimbal assembly for the dressing bar holder of FIG. 14, in accordance with an embodiment of the present invention.

FIG. 19 is an exploded perspective view of a dressing bar assembly with a hydrostatic fluid bearing, in accordance with an embodiment of the present invention.

FIG. 20 is a perspective view of the dressing bar assembly of FIG. 19 as assembled, in accordance with an embodiment of the present invention.

FIG. 21 is a perspective view of a dressing bar assembly with mechanical actuators, in accordance with an embodiment of the present invention.

FIG. 22 is a perspective view of the dressing bar assembly of FIG. 21, in accordance with an embodiment of the present invention.

FIG. 23 is a bottom perspective view of a dressing bar assembly of FIG. 21, in accordance with an embodiment of the present invention.

FIG. 24 is an exploded perspective view of an alternative mechanically actuated dressing bar assembly, in accordance with another embodiment of the present invention.

FIG. 25 is a bottom view of the alternative mechanically actuated dressing bar assembly of FIG. 24, in accordance with another embodiment of the present invention.

FIG. 26 is an exploded view of yet another alternate dressing bar assembly with mechanical actuators, in accordance with an embodiment of the present invention.

FIG. 27A is a plan view of a gimbal assembly for the dressing bar assembly of FIG. 26, in accordance with an embodiment of the present invention.

FIG. 27B is a close up plan view of a gimbal assembly for the dressing bar assembly of FIG. 27A, in accordance with an embodiment of the present invention.

FIG. 28 is a perspective view of a mechanically actuated dressing bar assembly attached to a hydrostatic bearing, in accordance with an embodiment of the present invention.

FIG. 29 is a perspective view of an alternate button bearing, in accordance with an embodiment of the present invention.

FIG. 30 is a perspective view of a dressing bar with a plurality of button bearings of FIG. 29, in accordance with an embodiment of the present invention.

FIG. 31 is a side view of the dressing bar of FIG. 30, in accordance with an embodiment of the present invention.

FIG. 32 is a pressure profile for the button bearing of FIGS. 29-31, in accordance with an embodiment of the present invention.

FIGS. 33 and 34 illustrate a multi-layered gimbal assembly in accordance with an embodiment of the present invention.

FIG. 35 is a perspective views of a dressing bar assembly, in accordance with an embodiment of the present invention.

FIG. 36 is an explode perspective view of the dressing bar assembly shown in FIG. 35, in accordance with an embodiment of the present invention.

FIGS. 37A and 37B are perspective views of a dressing bar with an array of the hydrostatic ports, in accordance with an embodiment of the present invention.

FIG. 38 is a perspective view of an alternate dressing bar with a plurality of active surfaces surrounded by hydrostatic ports, in accordance with an embodiment of the present invention.

FIG. 39 is a perspective view of an alternate dressing bar with a plurality of active surfaces surrounded by hydrostatic ports and a set of leading and trailing edge pads, in accordance with an embodiment of the present invention.

### DETAILED DESCRIPTION OF THE INVENTION

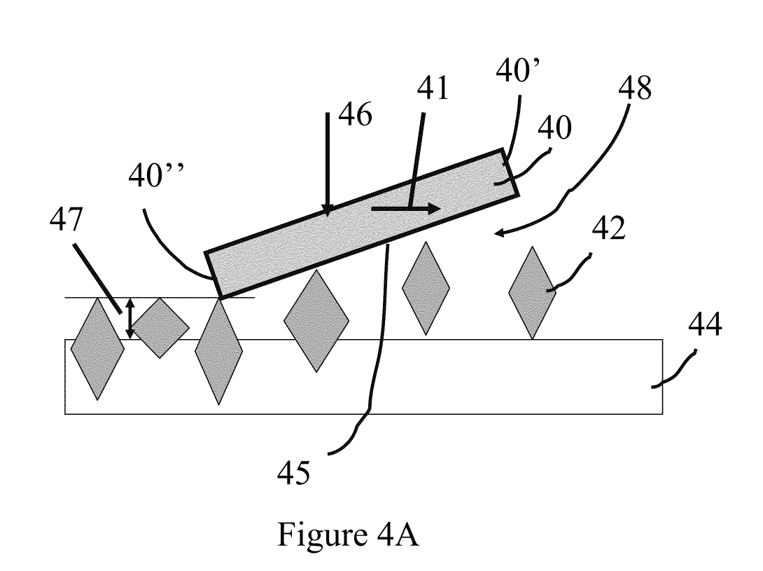

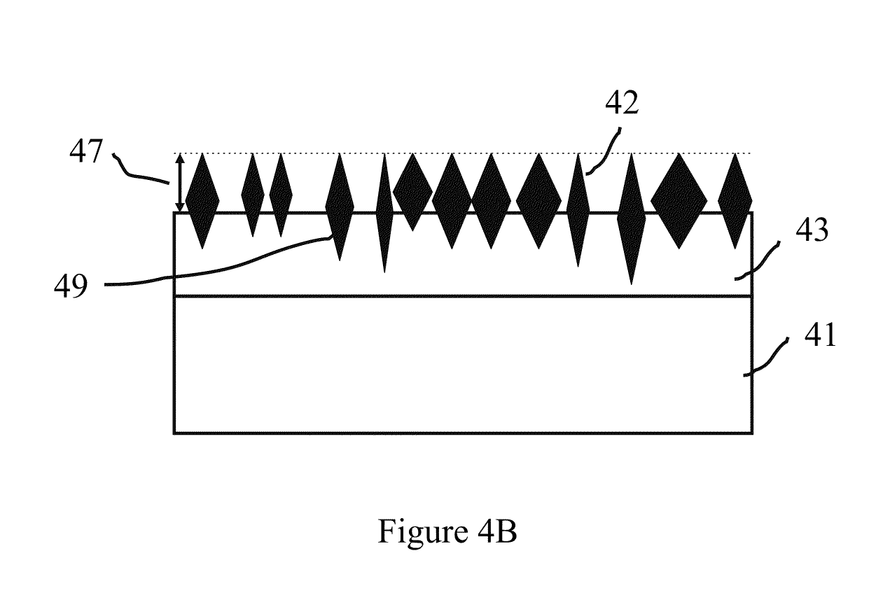

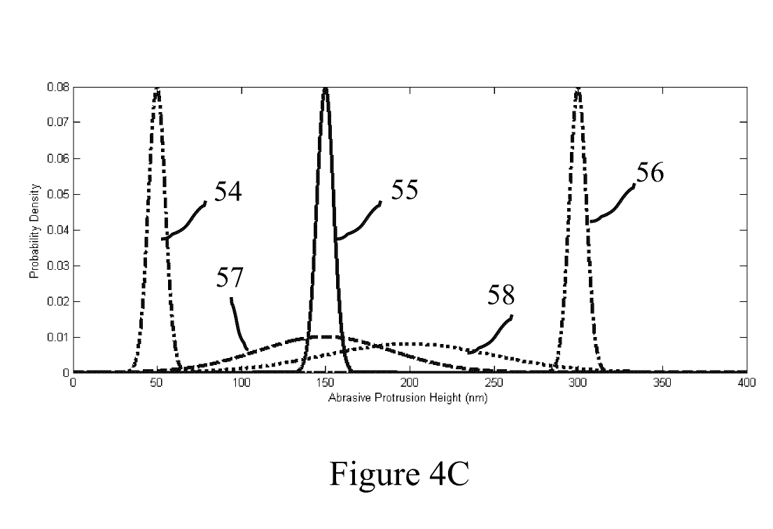

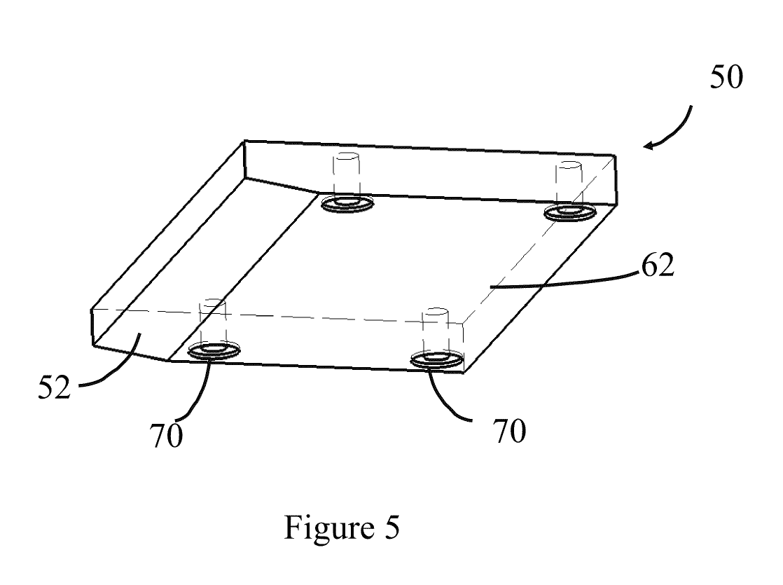

FIG. 4A is a schematic illustration of dressing bar 40 passing over a substrate 44. The dressing bar 40 is moved relative to the substrate 44, as indicated by arrow 41. The dressing bar 40 includes a leading edge 40′ and a trailing edge 40″. The dressing bar 40 uses a progressive interference to embed abrasive particles 42 into substrate 44. Progressive interference refers to a tapering gap interface 48 between active surface 45 of the dressing bar 40 and the substrate 44. In the illustrated embodiment, the dressing bar 40 is at an angle with respect to the substrate 44 to progressively embed the abrasive particles 42 into the substrate 44, resulting in a constant clearance 47 of the abrasive particles 42 relative to the substrate 44. The substrate 44 is also called a lapping plate after the particles 42 are embedded into the substrate 44. The interference can be adjusted by changing the clearance 47 at the trailing edge 40″ of dressing bar 40, the slope of the active surface 45 relative to the substrate 44, adding a taper to the dressing bar (see FIG. 5A), or a combination thereof. Preload 46 may be in the range of about 1 kilogram, depending on a number of variables, such as for example, the size of the abrasive particles 42, the material of the substrate 44, and the like. As used herein, “clearance” refers to a distance between an active surface of the trailing edge of a dressing bar and a substrate.

In one embodiment, the abrasive particles 42 are distributed the substrate 44 before application of the dressing bar 40.

During the particle embedding process a fluid bearing is formed at the interface 48 and controls the stiffness of the dressing bar 40 in the normal direction, pitch direction, and roll direction. Active surface 45 of the dressing bar 40 imparts a generally constant downward load 46 embedding the abrasive particles 42 further into the substrate 44. The spacing control between the dressing bar 40 and the substrate 44 assure a constant height 47 of the abrasive particles 42.

FIG. 4B illustrates a lapping plate 41 obtained from the embedding operation performed in FIG. 4A. As mentioned previously, the lapping plate 41 is the substrate 44 after the particles, such as diamonds 42, have been embedded into the substrate 44. The lapping plate 41 shown is characterized by the substantially uniform height 47′ of the abrasive particles 42. The height 47′ of the abrasive particles 42 above the surface in which they are embedded substantially matches the trailing edge spacing 47 (shown in FIG. 4A) between the dressing bar 40 and the substrate 44. Note that the abrasive particles 42 are embedded at different depths 49 due to their non uniform initial dimensions. In this embodiment the lapping plate 41 has a substantially uniform abrasive height. The particles 42 progressively penetrates the soft layer 43 of the lapping plate 41.

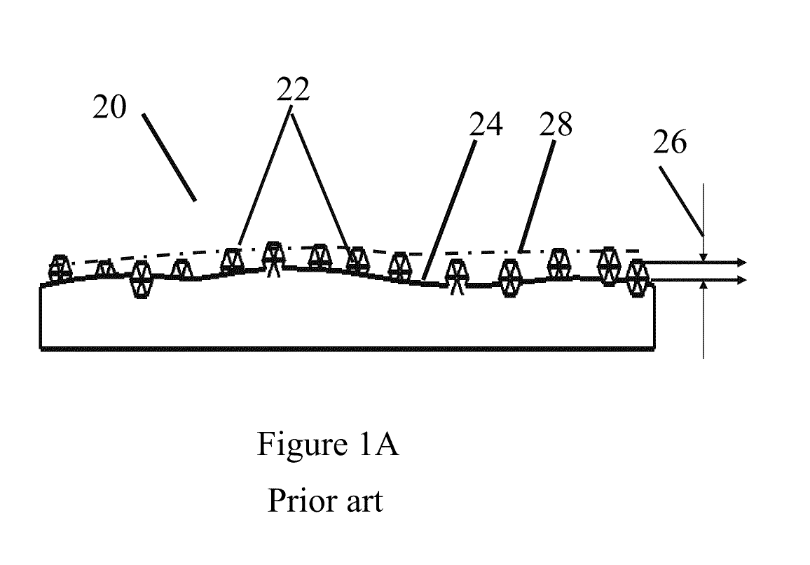

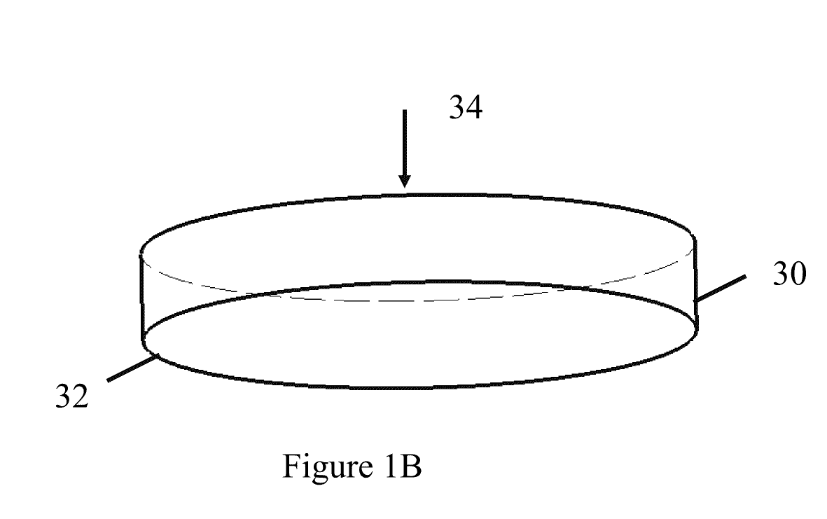

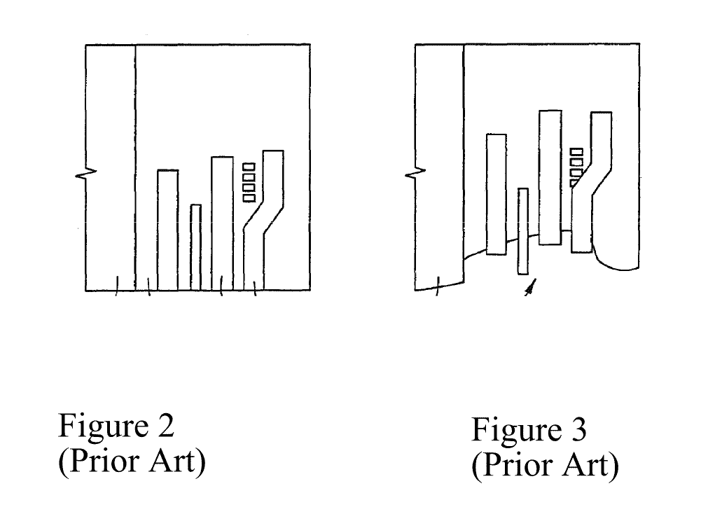

FIG. 4C gives a probability density of the abrasive protrusion distribution based on prior art as depicted by the distributions 57 and 58. A traditional dressing wheel 30 (shown in FIG. 1B) causes a wide height distribution during the particle embedding with a variable mean and a wide sigma, as depicted by 57 and 58. The distributions carrying the reference numbers 57 and 58 represent the prior art. The present invention purposely matches the desired abrasive particle protrusion height from the plate height to the minimum spacing between the dressing bar 40 and the lapping plate or substrate. Curves 54, 55 and 56 illustrate example result distributions of the present embodiment where desired protrusion heights of 50 nm, 150 nm, and 300 nm, respectively, can be achieved with a tight sigma of 3 nm for illustrative purposes.

FIG. 5 illustrates dressing bar 50 equipped with a tapered leading edge 52, in accordance with an embodiment of the present invention. The tapered leading edge 52 promotes progressive interference of abrasive particles into the soft layer of the plate. Methods of uniformly dispersing nanometer size abrasive grains are disclosed in U.S. Pat. Pub. No. 2007/0107317 (Takahagi et al.).

In a clearance dominated approach, the clearance between the diamond plate or substrate 40 (shown in FIG. 4A) and the dressing bar 50 can be controlled via a hydrodynamic film or hydrostatic film. The force generated by the fluid film is designed to be substantially higher than the countering forces emanating from the embedded diamond particles 42 into the substrate. Upon interference of the dressing bar 50 with respect to the abrasive particles 42, the later will offer little resistance to the force applied by the dressing bar 50.

The substrate 44 of FIGS. 4A and 4B can be made from a variety of materials. For example, the substrate 44 can be made of tin, a variety of other metals, polymeric materials, copper, ceramics, or composites thereof. The substrate 44 can also be flexible, rigid, or semi-rigid.

In one embodiment, a hard coat is applied to the surfaces 52, 62 of the dressing bar 50. The hard coat provides further protection to these surfaces. The desired thickness of the hard coat can be in the range of about 30 nanometers or greater. In one embodiment, the hard coat is diamond-like carbon (“DLC”) with a thickness of about 100 nanometers to about 200 nanometers. It is highly desirable to generate DLC hardness in the range of 70-90 Giga-Pascals (“GPA”). In other embodiments, the hard coat is TiC, SiC, AlTiC.

In one embodiment the DLC is applied by chemical vapor deposition. As used herein, the term “chemically vapor deposited” or “CVD” refer to materials deposited by vacuum deposition processes, including, but not limited to, thermally activated deposition from reactive gaseous precursor materials, as well as plasma, microwave, DC, or RF plasma arc-jet deposition from gaseous precursor materials. Various methods of applying a hard coat to a substrate are disclosed in U.S. Pat. No. 6,821,189 (Coad et al.); U.S. Pat. No. 6,872,127 (Lin et al.); U.S. Pat. No. 7,367,875 (Slutz et al.); and U.S. Pat. No. 7,189,333 (Henderson).

Abrasive particles of any composition and size can be used with the method and apparatus of the present invention. The preferred abrasive particles 54 are diamonds with primary diameters less than about 1 micrometer, also referred to as nano-scale diamonds. For some applications, however, the diamonds can have a primary diameter of about 100 nanometers to about 20 micrometers. The abrasive particles 42 (shown in FIGS. 4A and 4B) can also be present in the form of an abrasive agglomerate. The abrasive particles in each agglomeration can be held together by an agglomerate binder. Alternatively, the abrasive particles 42 can bond together by inter-particle attraction forces. Examples of suitable abrasive particles include fused aluminum oxide, heat treated aluminum oxide, white fused aluminum oxide, porous aluminas, transition aluminas, zirconia, tin oxide, ceria, fused alumina zirconia, or alumina-based sol gel derived abrasive particles.

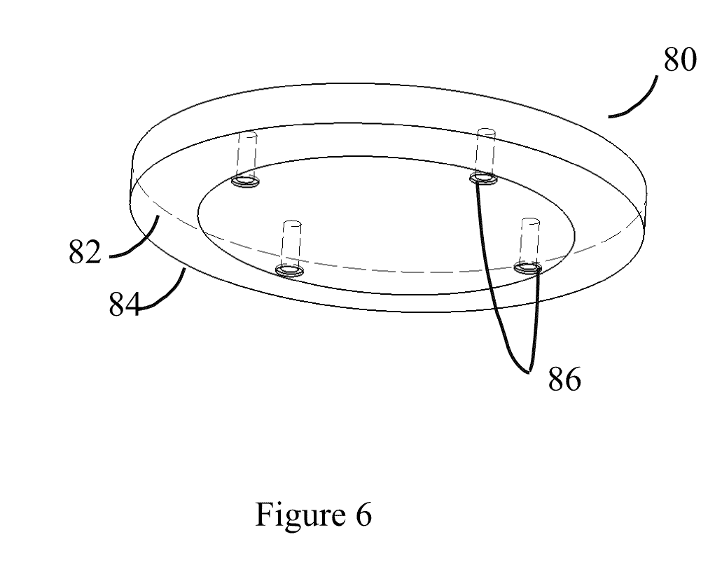

FIG. 6 illustrates a circular dressing bar 80 with a tapered edge 82 extending substantially around the perimeter 84 of the dressing bar 80, in accordance with an embodiment of the present invention. The dressing bar 80 optionally includes hydrostatic ports 86, that are further discussed and detailed below.

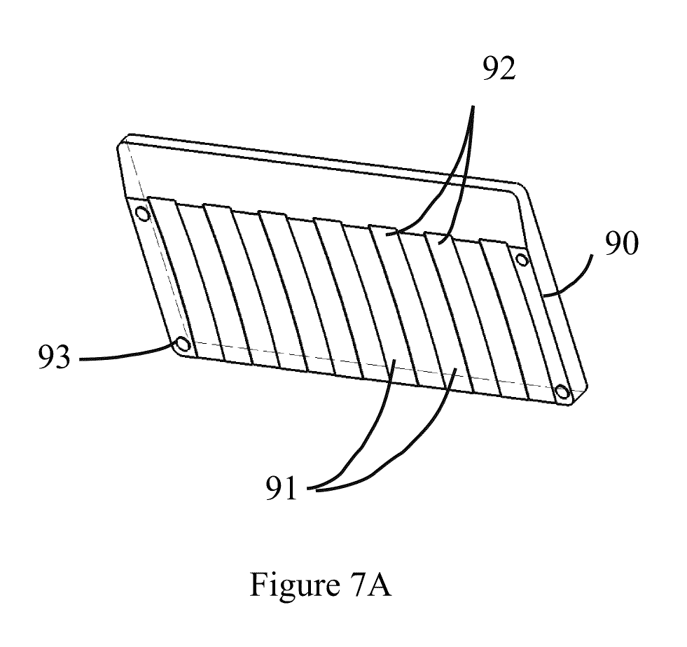

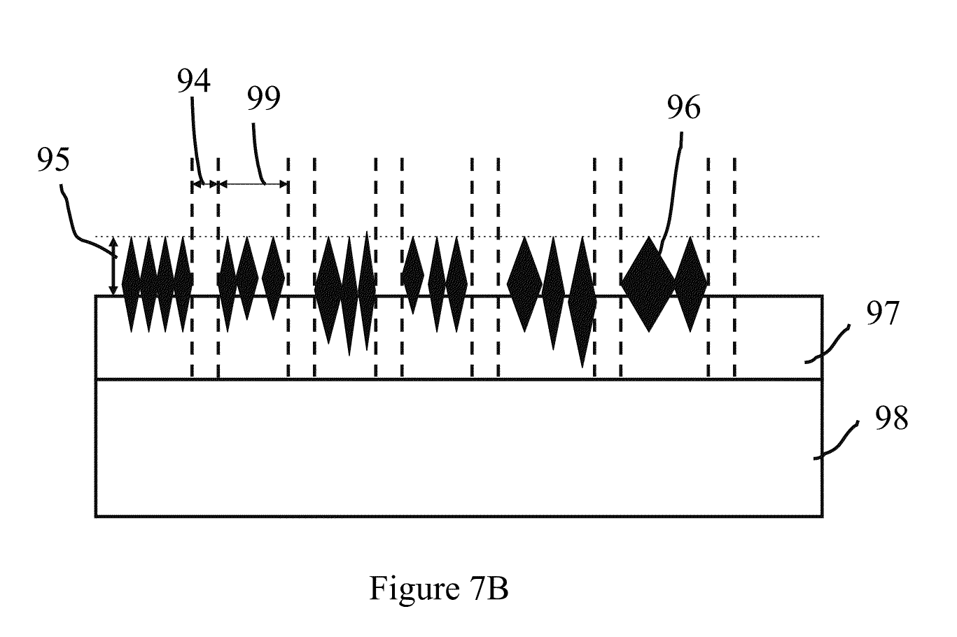

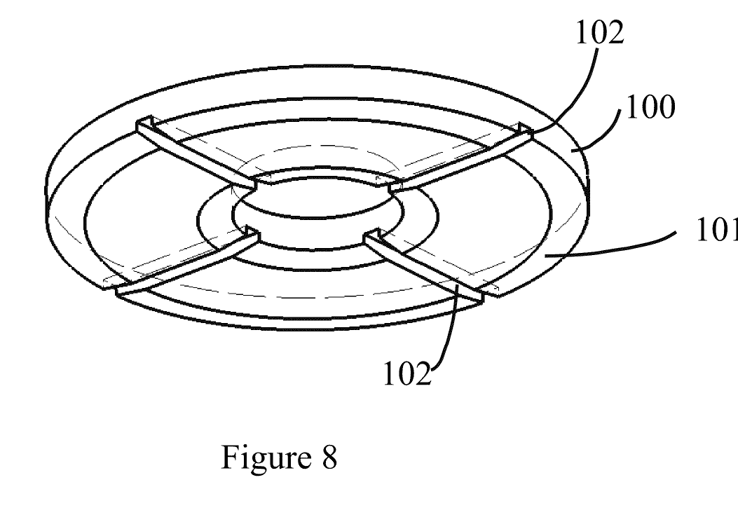

FIG. 7A illustrates an alternate dressing bar 90 with slots or grooves 92 in accordance with an embodiment of the present invention. During the embedding process, the abrasive particles are displaced into the grooves 92, simulating grooves on the resulting substrate, without the need for a machining step.

FIG. 7A illustrates an alternate dressing bar 90 having slots or grooves 92 therein, in accordance with an embodiment of the present invention. FIG. 7B illustrates a lapping plate 98 obtained from the embedding operation performed in FIG. 7A. Now referring to both FIGS. 7A and 7B, the grooves 92 are fabricated to reduce the magnitude of the hydrodynamic fluid bearing. The grooves are recessed with respect to land 91 and do not participate in embedding the abrasive particles 96 into the substrate. The grooves 92 also control the amount of abrasive particles 96 being embedded at any giving time. The grooves 92 also reduce the required preload. The grooves 92 can also be used for form a patterns of abrasive particles in the substrate or lapping plate 98. The dressing bar 90 includes a tapered leading edge 90′ and a trailing edge 90″. The dressing bar 90 is passed over the substrate 98 in a fashion similar to that shown in FIG. 4A.

The substantially uniform height 95 of the abrasive particles 96 matches the trailing edge 90″ spacing (such as trailing edge spacing 47 shown in FIG. 4A) between the dressing bar 90 and the substrate 98. Note that the abrasive particles 96 are embedded at different spacing configurations 94 and 99. The spacing 94 corresponds to the spacing between the grooves 92 and the land 91. In this embodiment, the lapping plate 98 formed has a substantially uniform abrasive height 95 with abrasive packs or portions spaced in accordance to the lands 91 and grooves 92 manufactured on the dressing bar 90. The particles 96 progressively penetrate the soft layer 97 of the lapping plate 98. As mentioned before, the substrate 98 is formed into a lapping plate 98 after the particles 96 have been embedded into the soft layer 97 of the substrate 98 by the dressing bar 90.

FIG. 8 is a circular dressing bar 100 with slots 102 that permit the abrasive slurry to circulate during the embedding process, in accordance with an embodiment of the present invention.

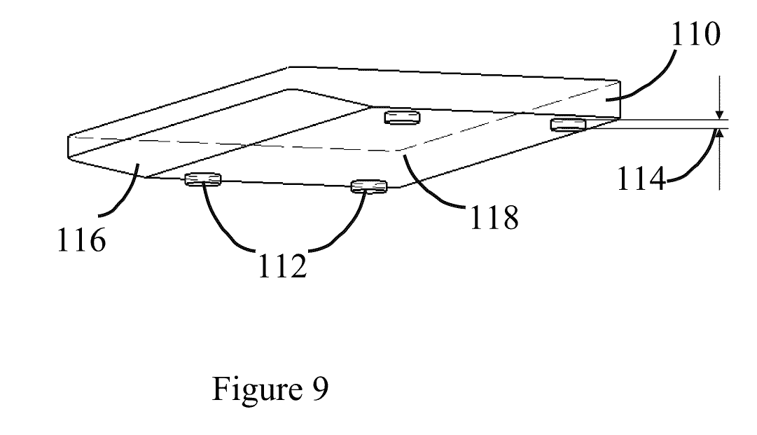

FIG. 9 is a perspective view of an alternate dressing bar 110 with low friction pads 112, in accordance with an embodiment of the present invention. The low friction pads 112 control spacing between the dressing bar 110 and the substrate, such as substrate 44 or 98 (shown in FIG. 4A or 7B, respectively). The low friction pads 112 include a pre-defined height 114 that corresponds to the target height the abrasive particles are to extend above the substrate in the finished lapping plate, such as lapping plate 44 or lapping plate 98. The pads 112 assure a constant height during the entire dressing operation. It is envisioned that the low friction pads 112 displace the abrasive particles during the embedding process and engage with the substrate. In one embodiment, the pads 112 have heights of about 100 nanometers for use with abrasive particles having major diameters of about 200 nanometers to about 400 nanometers. The tapered region 116 forms an angle with respect to the flat region 118 of about 0.4 milli-radians.

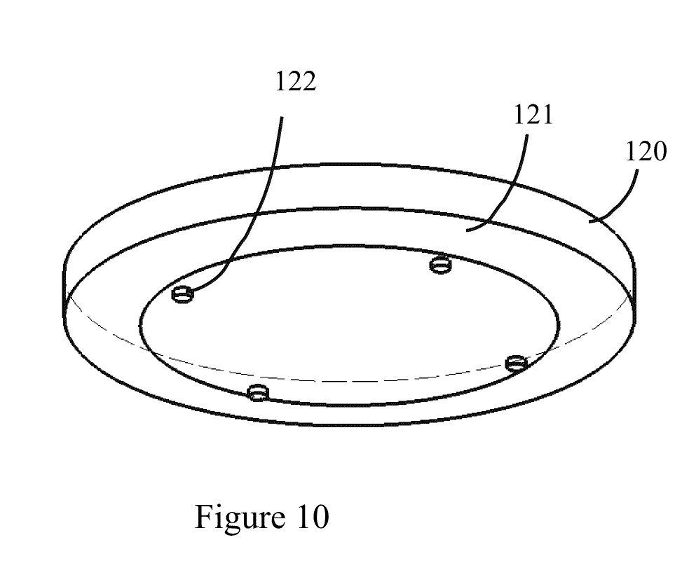

FIG. 10 is a perspective view of a circular dressing bar 120 with low friction pads 122 and a taper angle 121, as discussed above.

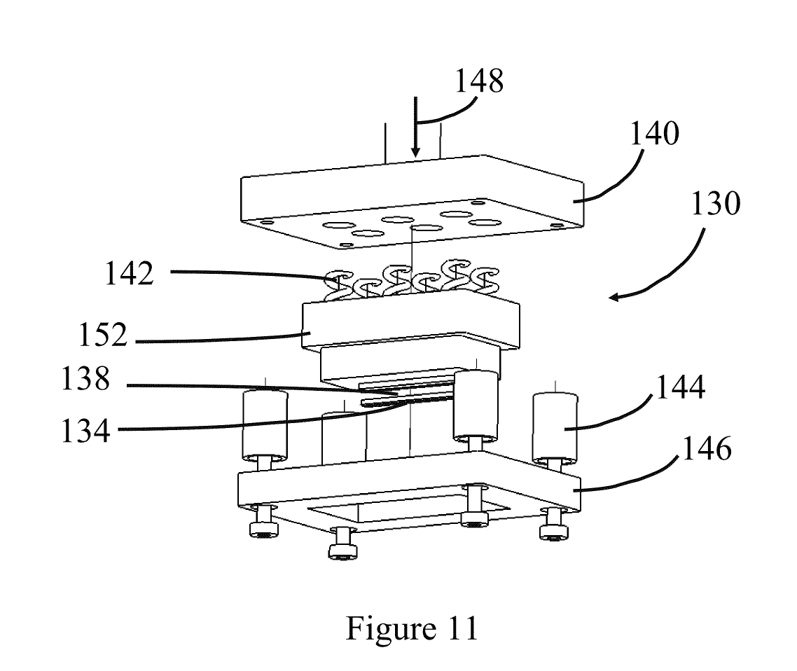

FIG. 11 illustrate a spring supported dressing bar assembly 130, in accordance with an embodiment of the present invention. The spring configuration 142 provides a preload to a dressing bar 134. A gimballing mechanism allows the dressing bar 134 to be topography following with respect to the lapping plate (not shown). The spring configuration 142 provides a preload. The gimballing structures allow the dressing bar 134 to pitch and roll. A fluid bearing balances the structural forces generated by the spring arrangement. As used herein, “fluid bearing” refers generically to a fluid (i.e., liquid or gas) present at an interface between the dressing bar 134 and a substrate (not shown) that applies a lift force on the dressing bar 134. Fluid bearings can be generated hydrostatically, hydrodynamically, or a combination thereof.

Fluid bearing geometries on an active surface of the dressing bar 134 play a role in pressurization of a fluid bearing. Possible geometries in the active surface of the dressing bar 134 include tapers, steps, trenches, crowns, cross curves, twists, wall profile, and cavities. Finally, external factors such as viscosity of the bearing fluid and linear velocity play an extremely important role in pressurizing bearing structures.

The dressing bar 134 is attached to a bar holder 138. Bar holder 138 is engaged with preload fixture 140 by a series of springs 142. The bar holder 138 is captured between base plate 152 and a preload structure, which is comprised of a preload fixture 140 and springs 142. The preload fixture 140 and the springs 142 are attached to a base 146. Spacers 144 assure that the springs 142 are preloaded prior to engaging the dressing bar 134 with the substrate (not shown). The springs 142 permit the bar holder 138 to gimbal with respect to the preload structure 140.

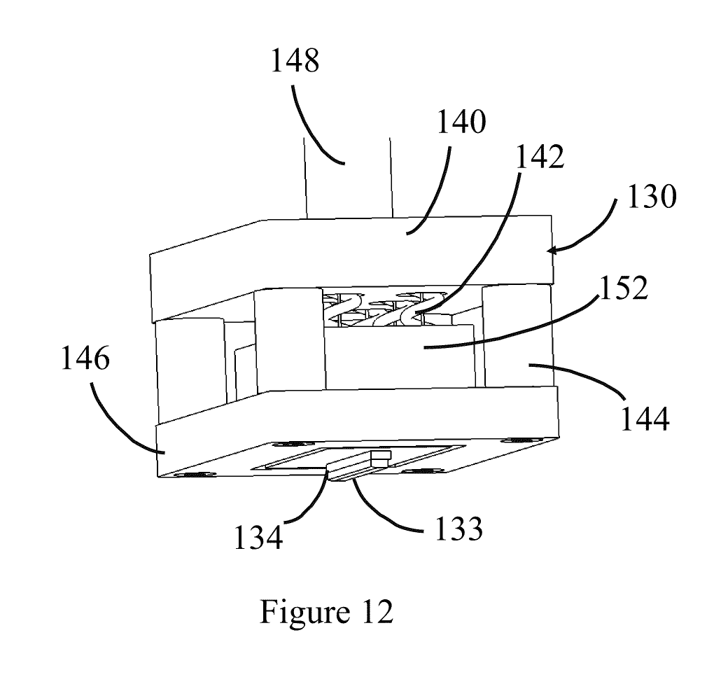

FIG. 12 is a schematic illustration of the apparatus shown in FIG. 11 as assembled. FIG. 12 shows the engagement between the dressing bar 134 with the base 146, in accordance with an embodiment of the present invention. The dressing bar 134 is shown in a position where it would engage a substrate (not shown) during the process of embedding particles into the substrate to form a lapping plate. The preload fixture 140 presses the springs 142. The amount of preload fixture is attached to the base 146 using fasteners. The amount of preload is limited by the spacers 144. The longer the spacers, the less amount of preload.

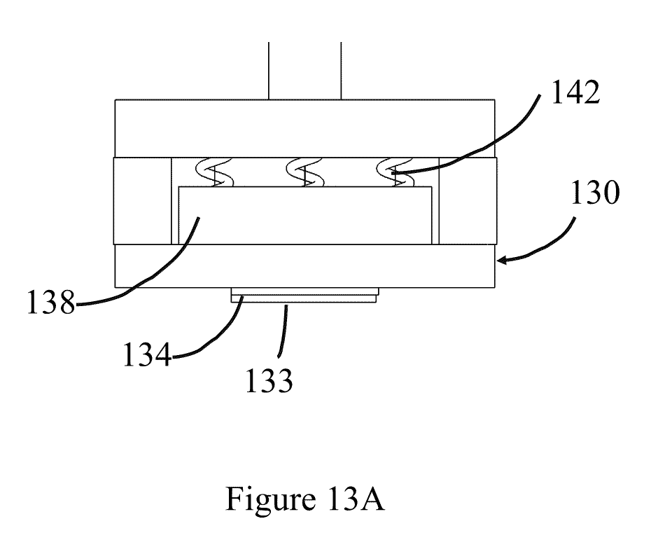

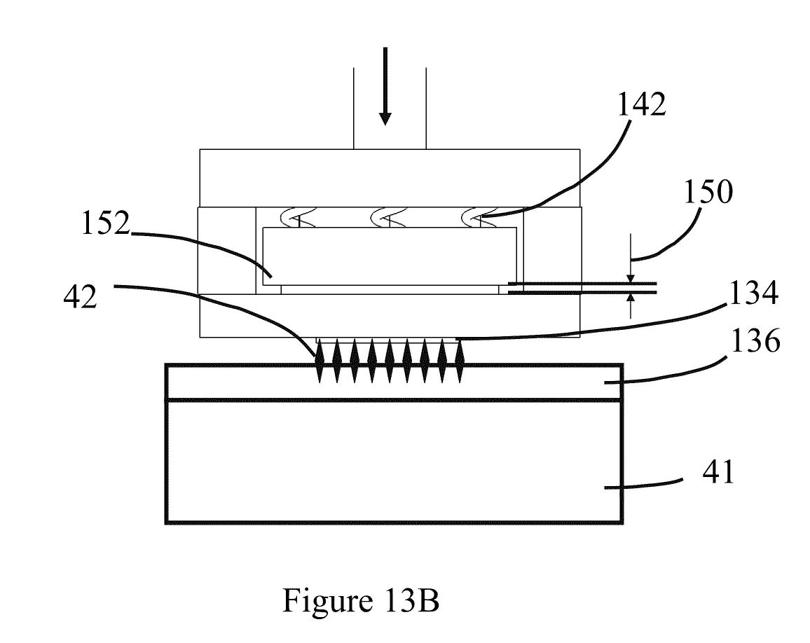

FIG. 13A illustrate the dressing bar assembly 130 before engagement with substrate 136. FIG. 13B illustrate the dressing bar assembly 130 after engagement with substrate 136. As illustrated in FIG. 13A, the springs 142 bias the bar holder 138 into engagement with the base 146. The dressing bar 134 is at it maximum extension beyond the base 146 in FIG. 13A.

As illustrated in FIG. 13B, the dressing bar 134 is engaged with the substrate 136. This engagement of the dressing bar 134 with the substrate 136 acts in opposition of the force of the springs 142. When the dressing bar 134 is engaged with the substrate 136, the clearance gap 150 between shoulder 152 on the bar holder 138 and the base plate 146 is increased.

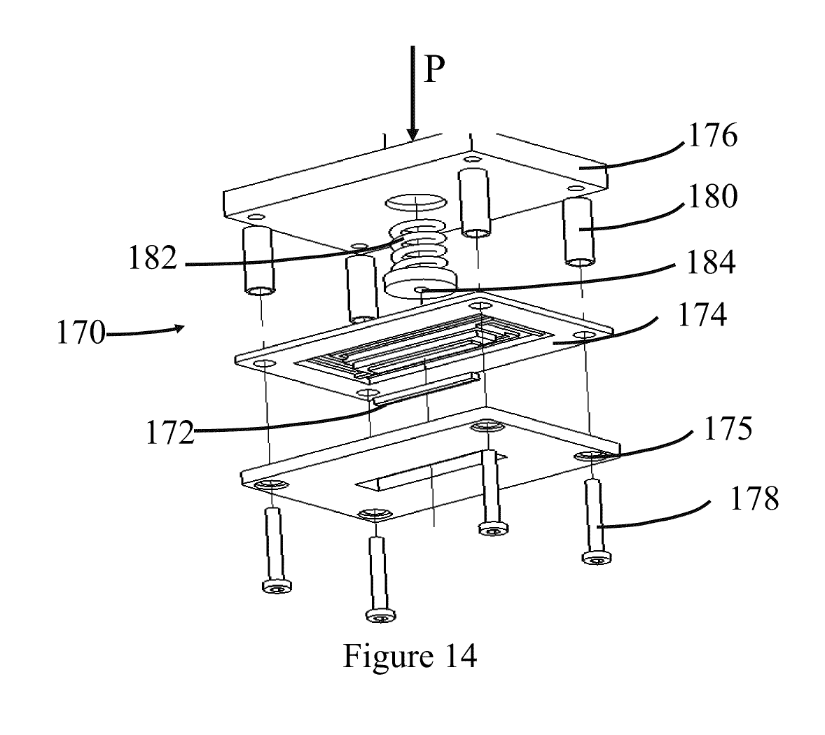

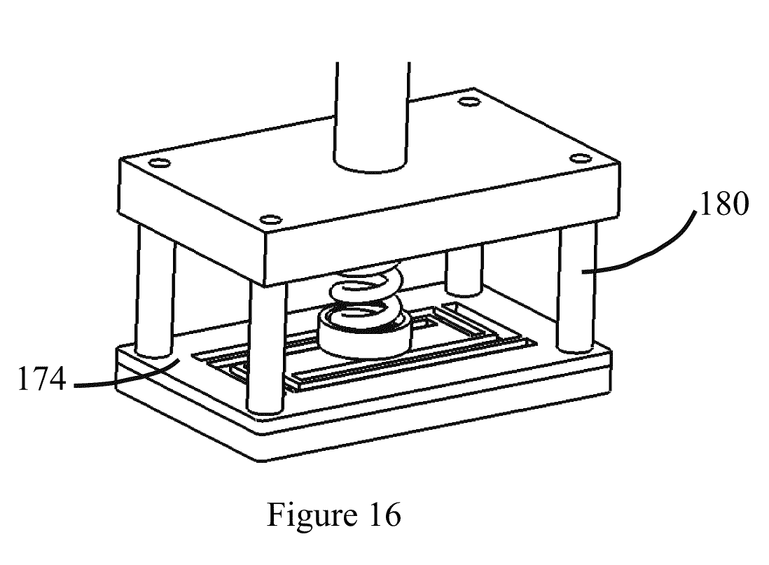

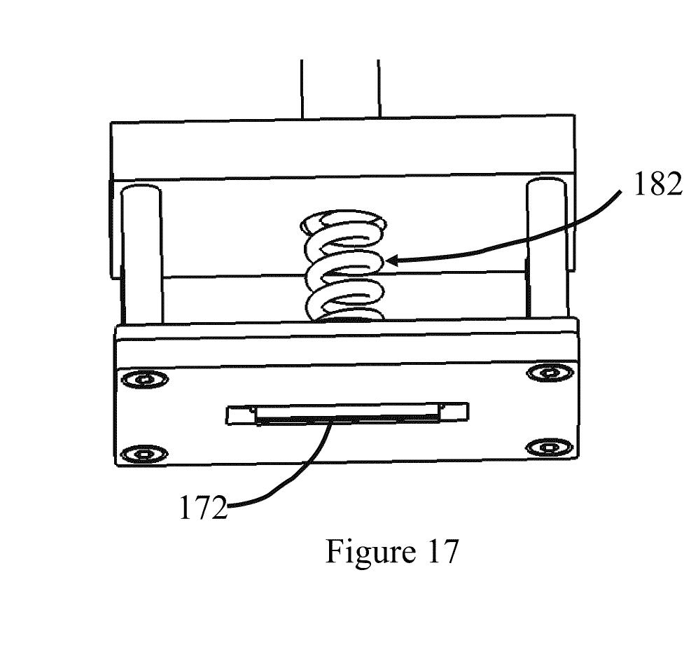

FIGS. 14 through 17 illustrate an alternate dressing bar assembly 170, in accordance with an embodiment of the present invention. Dressing bar 172 is attached to gimbal assembly 174, which is attached to preload structure 176 by fasteners 178 and spacers 180. The gimbal assembly 174 is captured between base plate 175 and the spacers 180.

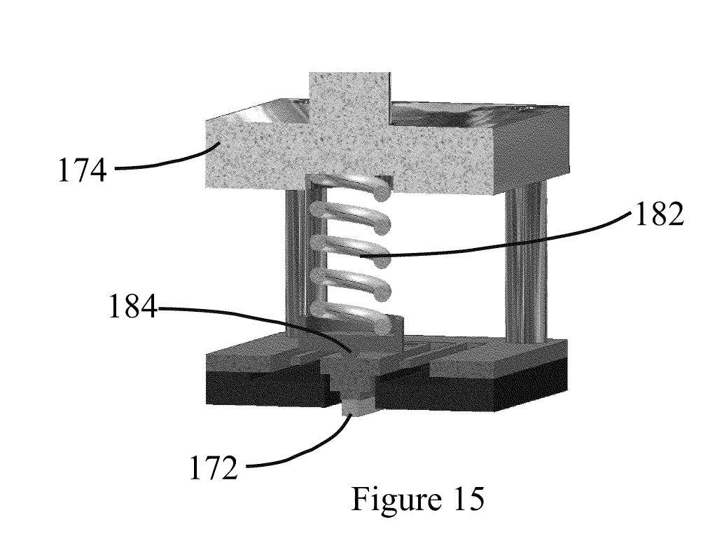

A spring assembly 182 transfers a preload force, P, from the preload structure 176 to the gimbal assembly 174. As best illustrated in FIG. 15, a dimple 184 is attached to one end of the spring assembly 182. The spring assembly 182 applies a point load from the gimbal assembly 174 to the dimple 184. The dimple 184 decouples the preload from the roll and pitch stiffness of the dressing bar 172. The spring assembly 182 is maintained in compression between the preload structure 176 and the base plate 175. The gimbal assembly 174 allows the dressing bar 172 to move vertically, and to pitch and to roll around the dimple 184. The dressing bar 172 meets all the conditions for establishing a fluid bearing with the substrate. The fluid bearing must be thinner than the dimension of the diamonds in order to permit interference embedding of the diamonds into the substrate to produce a lapping plate.

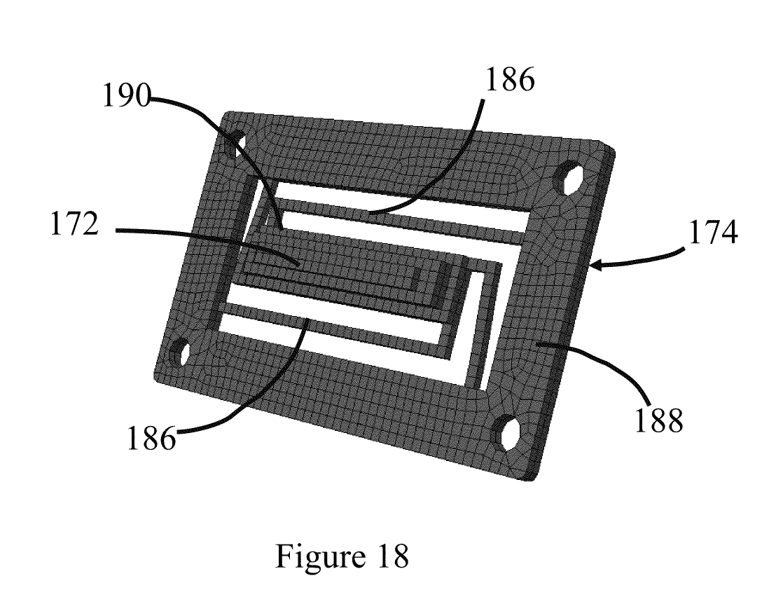

FIG. 18 is a perspective view of the gimbal assembly 174 with a dressing bar 172 attached, according to an embodiment of the invention. A series of springs 186 connect a fixed frame portion 188 to moving center portion 190. The dog-leg configuration of the spring segments 186 is well suited for out-of-plane deformation due to external load application. The displacement of the attached dressing bar 172 is substantially normal to the applied load with substantially minimal twist, roll, or pitch, which is very desirable in order to cause the dressing bar 172 to rest substantially flat with respect to the substrate (not shown). In particular, the dressing bar 172 moves substantially parallel to a plane defined by the applied load (such as load 148 shown in FIG. 11).

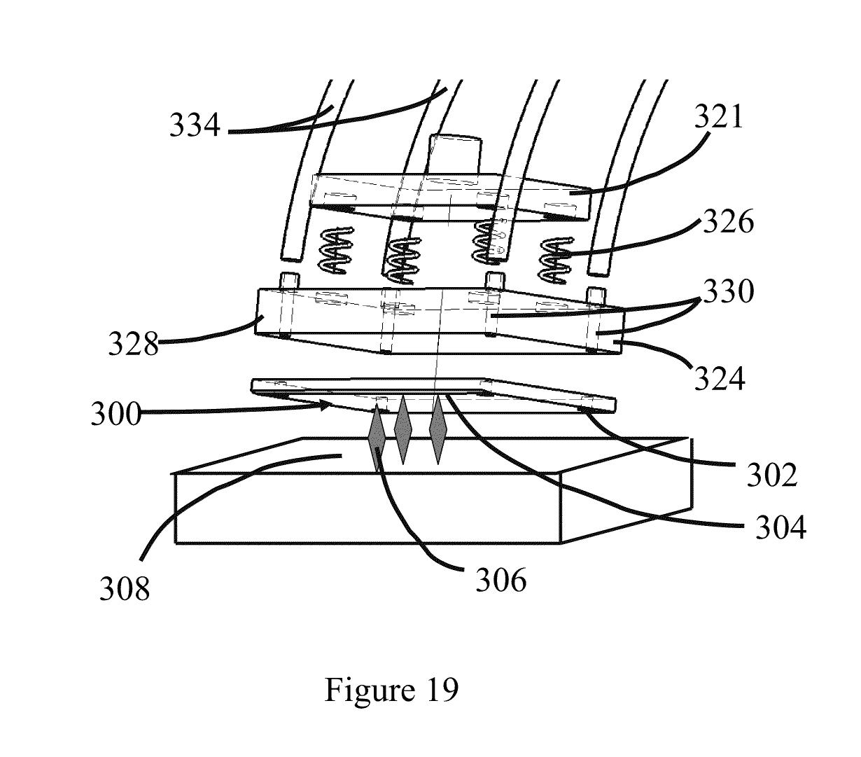

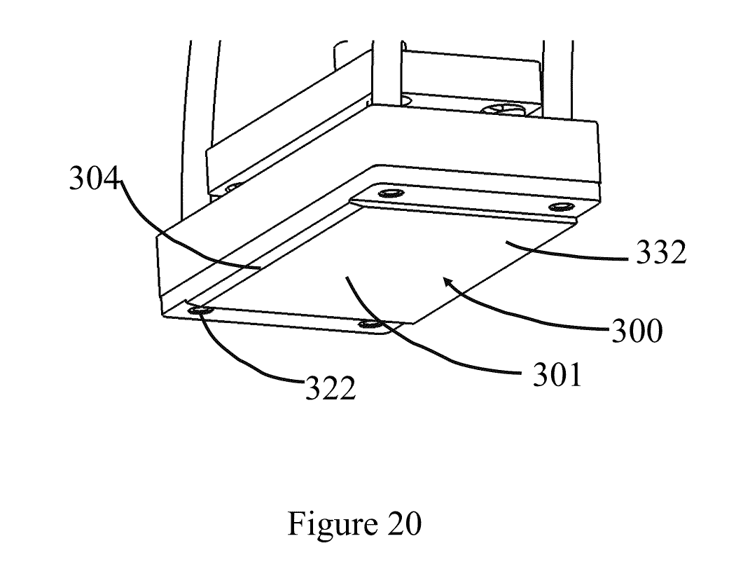

FIGS. 19-20 illustrate an embodiment of a dressing bar 300 with a hydrostatic fluid bearing 302, in accordance with an embodiment of the present invention. The dressing bar 300 includes tapered leading edge 304 progressively interfering with abrasive particles 306 on substrate 308. The abrasive particles enter interface with the tapered leading edge 304 of the dressing bar 300, thus embedding the abrasive particles into substrate. The particles 306 may be embedded further into the substrate as the dressing bar passes over the particles 306 from the leading edge to the trailing edge. The shape of the leading edge 304 can be linear or curvilinear depending on the clearance embedding force relationship desired during the abrasive embedding process.

As the substrate 308 moves relatively with respect to the dressing bar 300, the abrasive particles are progressively driven downward as a function of the interference level with active surface 301. When the particles have been driven down to a finished level, the substrate has been formed into a lapping plate.

The dressing bar 301 is suspended by a spring gimballing system 326 attached to a support structure 321. Gimbal mechanism 324 includes a series of springs 326 that provide preload roll torque and pitch torque to a buffer bar 328. The buffer bar 328 includes hydrostatic ports 330 in fluid communication with hydrostatic bearings 302 on the dressing bar 300.

A series of hydrostatic bearings 302 are formed in surface of the dressing bar 300. The ports 302 are in fluid communication with delivery tubes 334 providing a source of compressed air or other selected fluid. A hydrostatic force provides lift to the dressing bar 300 with roll, pitch and vertical stiffness. The hydrostatic force also controls the spacing with respect to the substrate 308 being made into a lapping plate.

A controller monitors gas pressure delivered to the slider dressing bar 300. Gas pressure to each of the four ports 330 is preferably independently controlled so that the pitch and roll of the slider dressing bar 300 can be adjusted. In another embodiment, the same gas pressure is delivered to each of the ports 330. While clean air is the preferred gas, other gases, such as for example, argon may also be used. The gas pressure is typically in the range of about 2 atmospheres to about 30 atmospheres. Once calibrated, the spacing between the dressing bar 300 and the substrate 308 can be precisely controlled.

The stiffness of the dressing bar 300 is determined by the relationship:

K=ΔF/Δh

where ΔF is the change of load caused by a change in spacing Δh between the dressing bar 300 and the substrate 308.

It is important to match the stiffness of the hydrostatic fluid bearing 302 to the change in spacing Δh. Note also that such relationship is generally nonlinear. The desired height of the abrasives embedded in the lapping plate is achieved by assuring a minimum clearance change Δh between the plate or substrate 308 and the dressing bar 300 during the particle embedding process. The minimum clearance of the dressing bar 300 is set equal to the desired final height of the abrasives, such as particles height 95 shown in FIG. 7B. The desired final embedded height of the abrasives is adjusted by controlling the hydrostatic pressure, Ps, leading to a desired spacing of the trailing edge of the dressing bar with respect to the substrate 308. The particles, when pressed or embedded into the substrate 308, form the lapping plate. A similar relationship can be drawn for pitch and roll stiffness.

Multiple design configurations can be envisioned for the dressing bar 300. Hydrostatic ports 322 can be machined into the dressing bar 300.

A fly height tester can be used to determine the relationship between the applied load on the dressing bar 300 and the spacing between the dressing bar 300 and the substrate 308. By varying the external pressure on the hydrostatic ports 330 fabricated onto the dressing bar 300, a desired minimal clearance matching the desired abrasive height and pitch and roll angles can be established for each dressing bar.

Alternate hydrostatic slider height control devices are disclosed in commonly discussed in “Fluid film lubrication” by William Gross and “Basic Lubrication Theory” by Alastair Cameron.

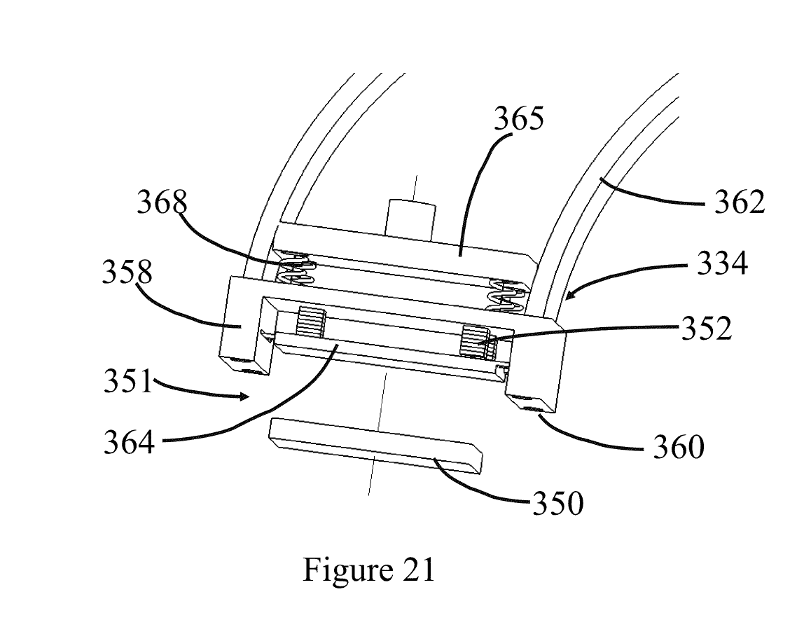

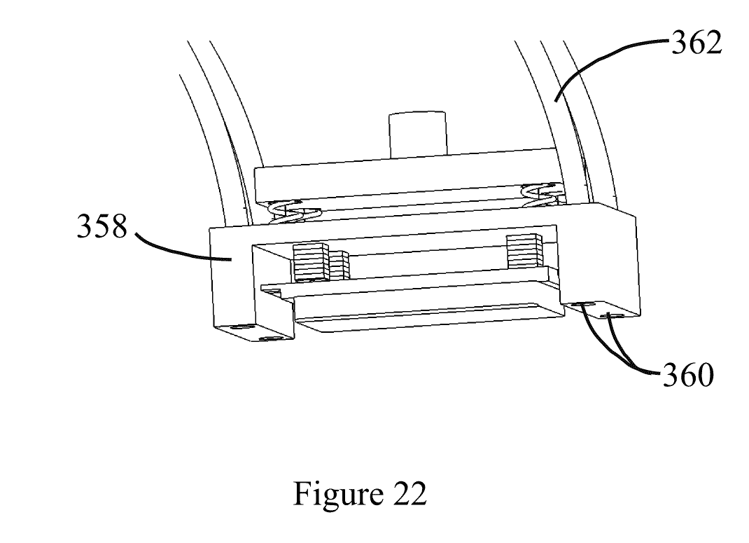

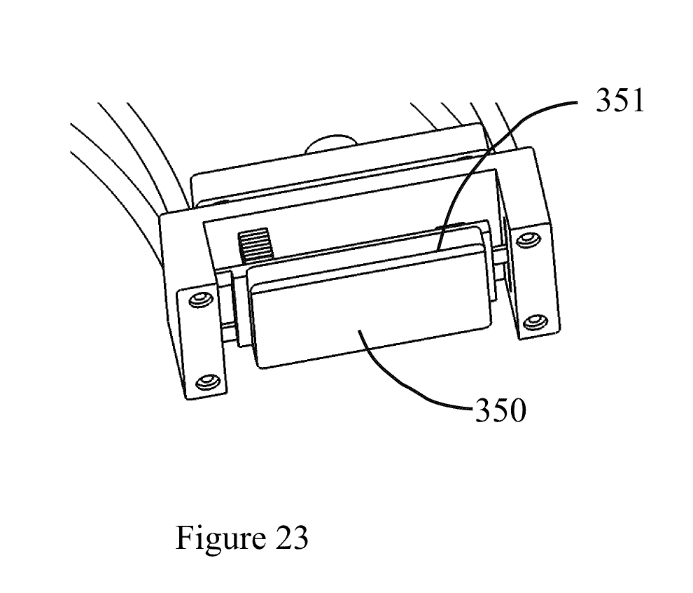

FIGS. 21-23 show a dressing bar 350 attached to a hydrostatic bearing mechanism 358 by actuators 352, according to an example embodiment of the invention. The attachment between the dressing bar 350 and the actuators 352 is critical for advancing the dressing bar 350 toward the substrate to form the lapping plate. The attachment between the dressing bar 350 and the actuators 352 is also critical for achieving a desired spacing profile. The actuators 352 can be controlled independently to adjust clearance, pitch, roll, and yaw of the dressing bar 350 relative to the lapping plate or substrate.

In operation, the actuators 352 advance the dressing bar 350 toward the substrate or lapping plate. The end effectors of the actuators 352 control push/pull the gimballing mechanism 364. As the actuators 352 are pushing and pulling the attitude including pitch, roll, and vertical location of the dressing bar 350 is mechanically controlled to a desired value.

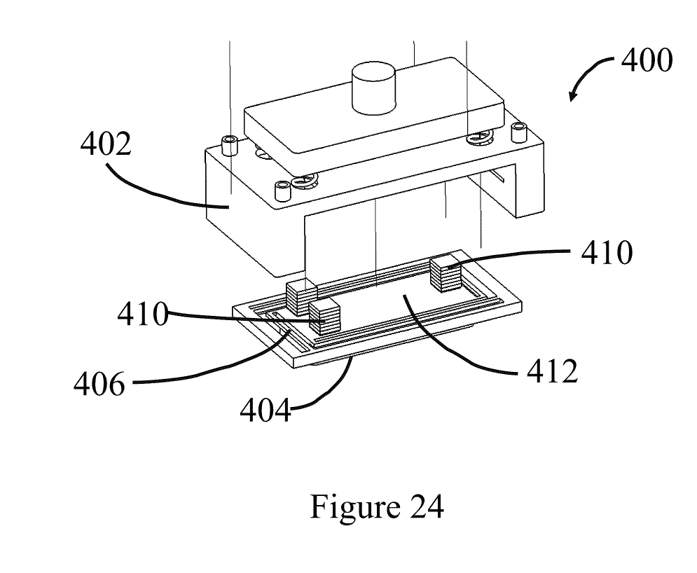

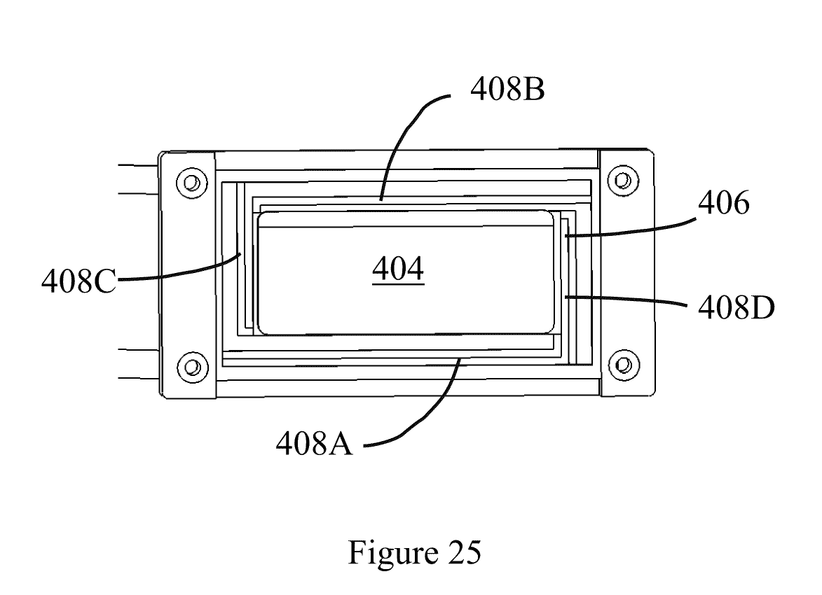

FIGS. 24 and 25 illustrate an alternate mechanically actuated dressing bar assembly 400 attached to a hydrostatic bearing mechanism 402, in accordance with an embodiment of the present invention. The hydrostatic bearing mechanism 402 operates as discussed in connection with FIGS. 21-23. The dressing bar 404 is attached to a gimbal assembly 406. Gimbal assembly 406 includes a series of spring arms 408A, 408B, 408C, 408D (collectively “408”) that permit the dressing bar 404 to move substantially out of plane while maintaining a desired pitch and roll. The gimbal assembly 406 is attached to the hydrostatic bearing mechanism or buffer bar 402. The actuators 410 are interposed between the buffer bar 402 and pad 412 on the gimbal assembly 406. The actuators 410 advance the dressing bar 404 toward the lapping plate or substrate (not shown).

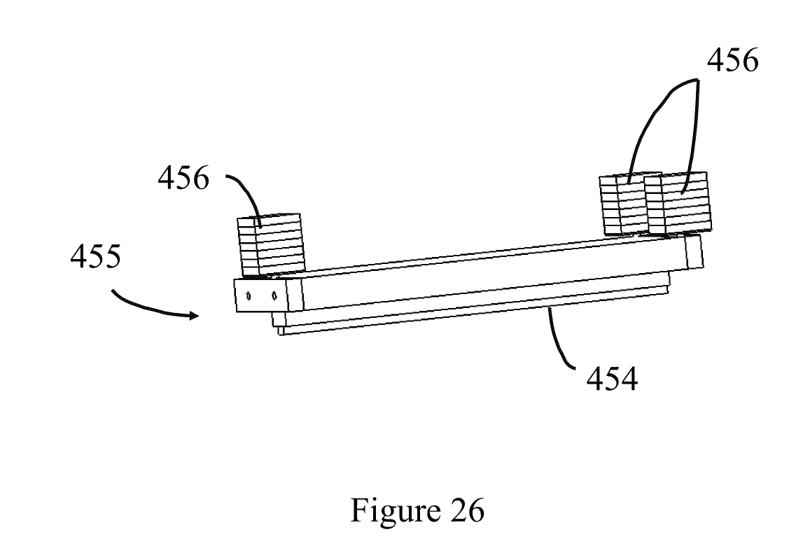

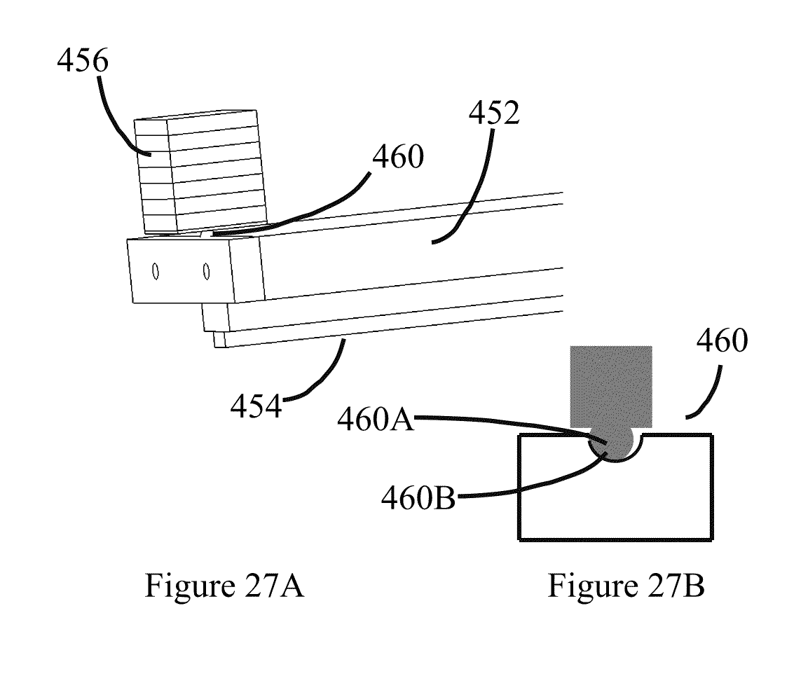

FIGS. 26-28 illustrate an alternate mechanically actuated dressing bar assembly 455 attached to a dressing bar 454, according to an example embodiment of the invention. Dressing bar 454 is attached using three actuators 456 arranged in a three-point push configuration. Ball and socket mechanism 460 is provided at the interface between micro-actuators 456 and the dressing bar 454. The micro-actuators may be piezoelectric, heaters to create thermal deformation, or a variety of other micro-actuators. FIG. 27A shows the ball and socket mechanism in further detail. The hydrostatic bearing mechanism 452 includes a ball 460B and the actuator 456 includes a socket 460A. The socket 460A has a smaller diameter than the ball 460B. In this way, the ball 460A makes an interference fit with the socket 460B. The ball and socket mechanism 460 minimizes vibrations and stresses transferred to the hydrostatic bearing mechanism 452. The ball and socket mechanism 460 allows the hydrostatic bearing mechanism 452 to rotate freely while being attached to the micro-actuators 456. The ball and socket mechanism 460 allow for a true planar relationship between the micro-actuators 456 and the hydrostatic bearing mechanism 452. The ball socket mechanism 460 preferably introduces minimal slack to avoid any undesired motion. The interference fit generates frictional forces enhancing the stability of the dressing bar 454 under external excitations.

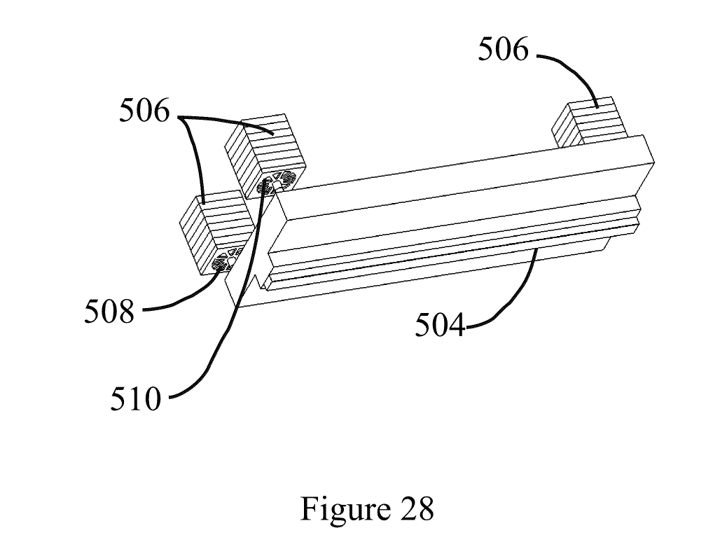

FIG. 28 illustrates an alternate mechanically actuated dressing bar assembly 500 attached to a hydrostatic bearing mechanism 502 in accordance with an embodiment of the present invention. The hydrostatic bearing mechanism 502 operates in substantially the same way as the hydrostatic bearing mechanism discussed in connection with FIGS. 21-25. Dressing bar 504 is attached to the hydrostatic bearing mechanism 502 using three actuators 506 arranged in a three-point push configuration. An elastic member 508 is located at interface 510 between the actuators 506 and the dressing bar 504. The elastic members 508 permit the dressing bar 504 to rotate relative to the actuators 506. The elastic members provide for limited rotation and motion. The elastic members are made from stainless steel, beryllium copper, aluminum, etc.

A fly height tester can be used to determine the relationship between the applied load on the dressing bar and the spacing between the dressing bar, such as dressing bar 301 and substrate 308. By varying the external pressure on the hydrostatic ports 302 in the hydrostatic bearing mechanism, a desired minimal clearance matching the desired abrasive height and pitch and roll angles can be established for each dressing bar 301 or 504.

Acoustic emission can also be used to determine contact between the dressing bar 504 and the substrate (not shown) in FIG. 28 by energizing the actuators. A transfer function between the actuators and the gimballing mechanism can be established numerically or empirically to determine the displacement actuation relationship.

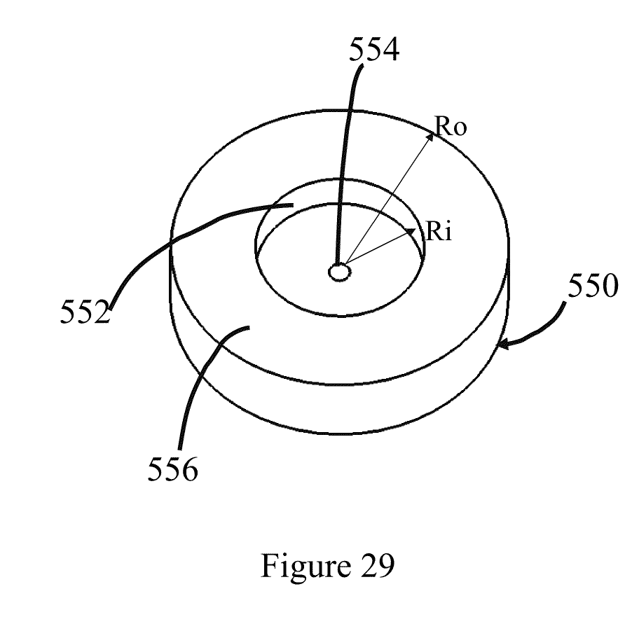

FIG. 29 illustrates a hydrostatic button bearing 550 having a cavity 552 therein. The cavity 552 is annular and has a radius Ri. The button bearing 550 also has a port 554 and an outer annular active surface 556, in accordance with an embodiment of the present invention. In one embodiment, Ro is about 2 millimeters and the ratio of Ri/Ro is about 0.87. The preload on the hydrostatic bearing is about 8.8 Newtons.

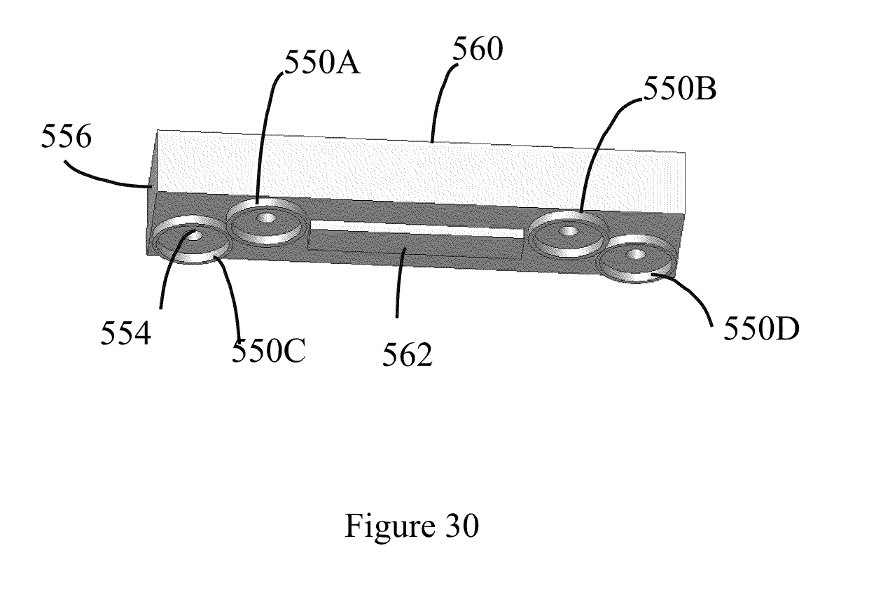

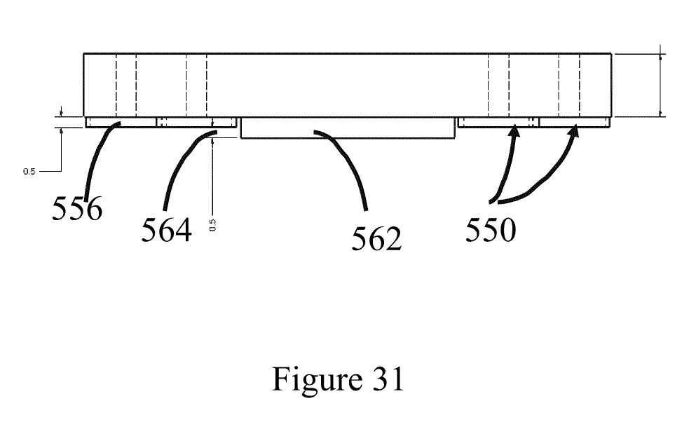

FIG. 30 is a perspective view of dressing bar 560 incorporating a plurality of button bearings, in accordance with an embodiment of the present invention. FIG. 31 is a plan view of dressing bar 560 incorporating a plurality of button bearings, in accordance with an embodiment of the present invention. More specifically, the dressing bar assembly 560 includes four of the button bearings 550A, 550B, 550C, 550D (“550”). Assuming a flow rate of about 10 milliliters/minute is delivered to the port 554, the pressure regulators generate a hydrostatic pressure about 0.8 Mega Pascals (MPa) in order to maximize the load carrying capacity. The resulting hydrostatic bearing has a clearance of about 1 micrometers measured between the active surfaces 556 and the substrate. As best illustrated in FIG. 31, the active surface 562 of dressing bar 560 extends a distance 564 of about 800 nanometers to about 900 nanometers above the active surfaces 556 of the button bearings 550, resulting in a spacing of the active surface 562 above the substrate of about 100 nanometers to about 200 nanometers. The pressure at leading edge button bearings 550A, 550B is preferably greater than at trailing edge button bearings 550C, 550D in order to pitch the dressing bar 560.

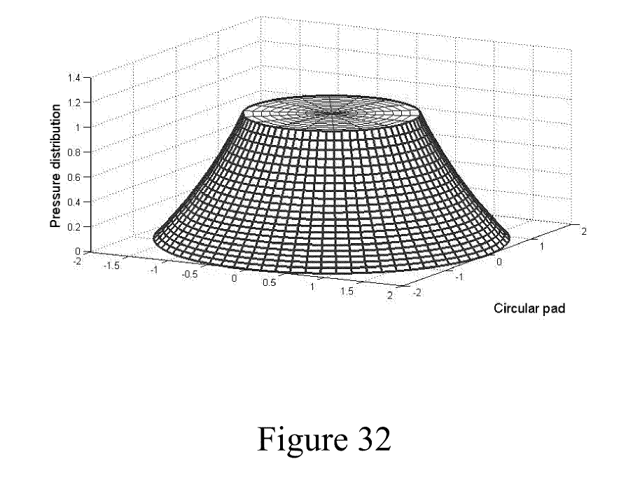

FIG. 32 shows a shape of the pressure distribution with a flat top pressure corresponding to the externally delivered pressure in the cavity 552 and the decaying pressure distribution along the bearing surface 554.

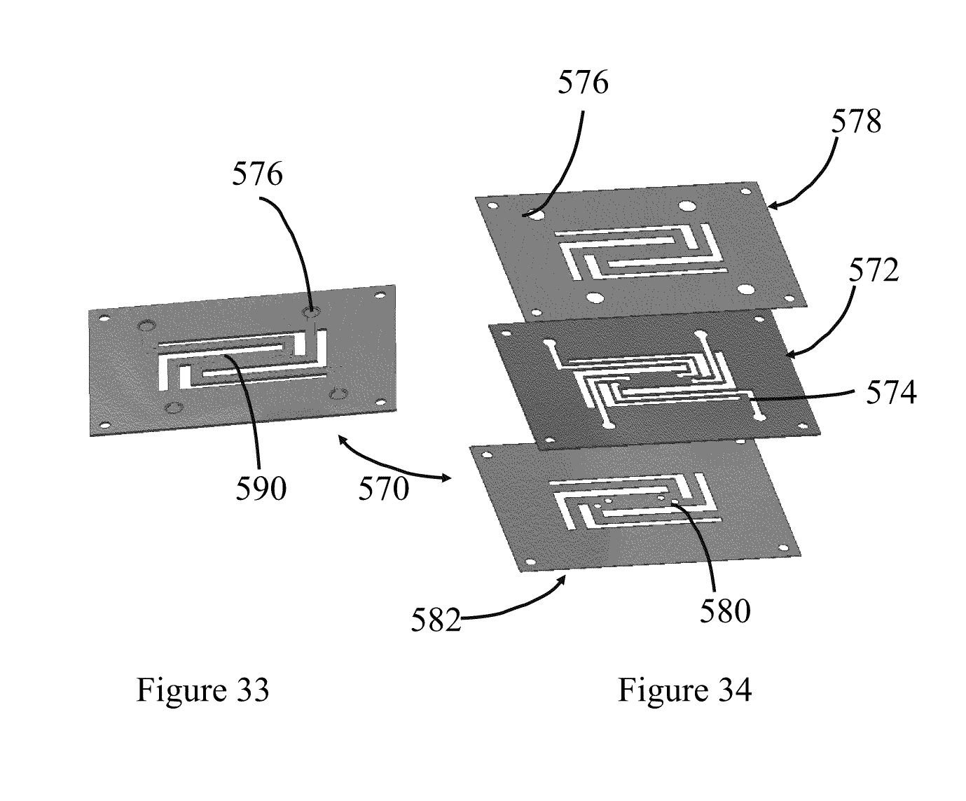

FIG. 33 is a perspective view of an assembled multi-layered gimbal assembly 570, in accordance with an embodiment of the present invention. FIG. 34 is an exploded view of a multi-layered gimbal assembly 570, in accordance with an embodiment of the present invention. In the illustrated embodiment, center layer 572 includes traces 574 that deliver compressed air from inlet ports 576 in the top layer 578 to exit ports 580 on the bottom layer 582. The exit ports 580 are fluidly coupled to the ports 554 on the button bearings 550. As best illustrated in FIG. 34, the inlet ports 576 are offset and mechanically decoupled from the gimbal mechanism 590.

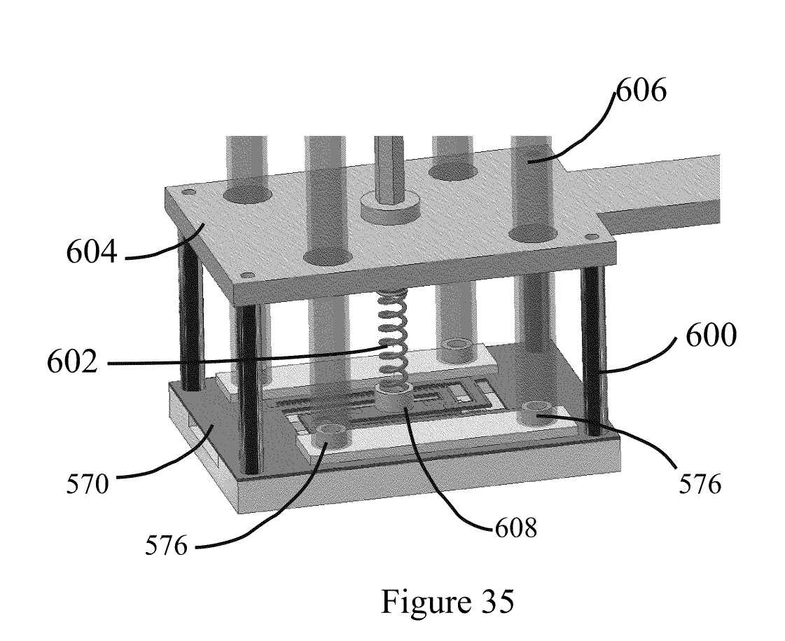

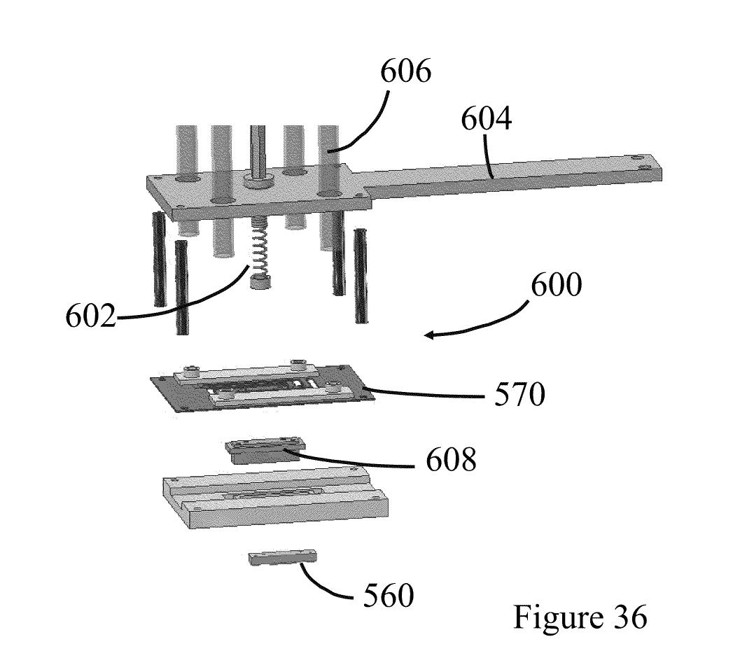

FIGS. 35 and 36 are perspective views of a dressing bar assembly 600, in accordance with an embodiment of the present invention. Spring load mechanism 602 delivers a preload of about 40 Newtons from the preload structure 604 to bar holder 608 and dressing bar 560. Of course other preload forces can be adjusted for various applications. Tubes 606 deliver compressed air or another fluids to each of the inlet ports 576 of the gimbal assembly 570. The fluid and the preload force form a fluid bearing of a selected thickness.

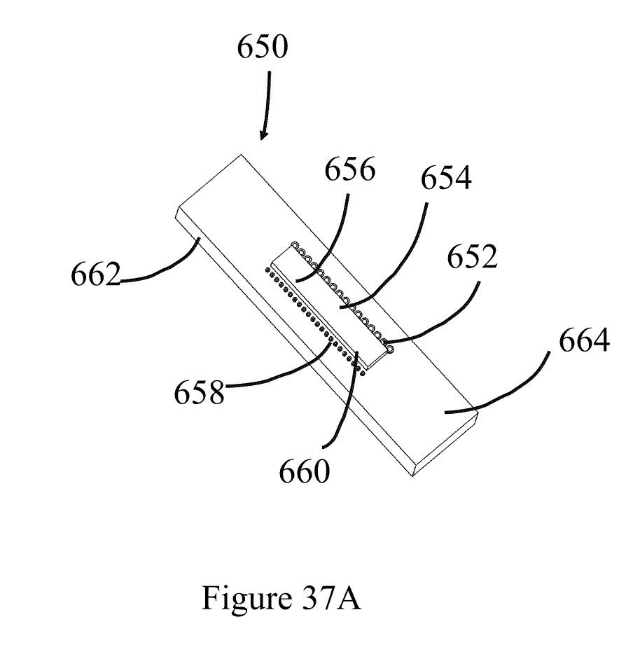

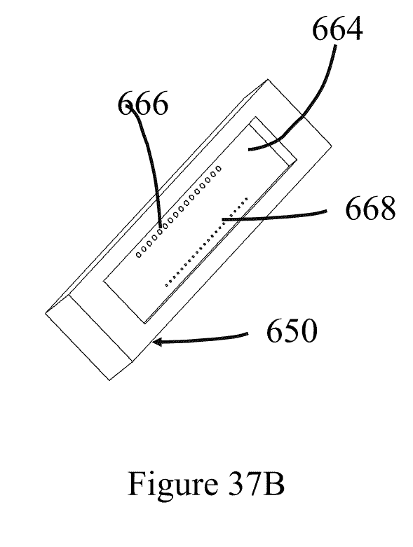

FIGS. 37A and 37B are front and rear perspective views of an alternate dressing bar 650, in accordance with an embodiment of the present invention. A first set of hydrostatic ports 652 are located adjacent to leading edge 654 of active surface 656 of the dressing bar 650. A second set of hydrostatic ports 658 are located adjacent to trailing edge 660 of active surface 656 of the dressing bar 650. The plurality of hydrostatic ports 652, 658 allows for a better averaging of the substrate waviness and a better overall topography following. The plurality of ports 652, 658 results in lower flow per port 652, 658 and allows for more accurate clearance control.

The hydrostatic ports in the first set 652 are, optionally, smaller than the hydrostatic ports in the second set 658 so leading edge 662 can be positioned higher above the surface than trailing edge 664. The smaller ports result in higher pressure for a given flow rate of fluid. The pressure in cavity 664 is generally uniform so the flow is delivered uniformly to each of the ports 666 and 668. Variations in incoming flow is seen by all the bearings 652, 658 causing minimal change in pitch and roll of the dressing bar 650, although the overall spacing of the dressing bar 650 will be effected by the changes in the flow. In an alternate embodiment, the cavity 664 is divided so one flow controller supplies the ports 652 and another flow controller supplies the ports 658.

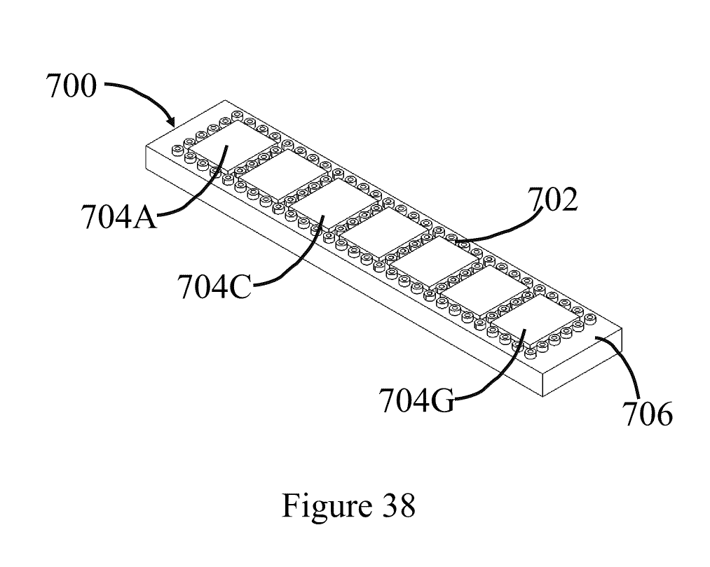

FIG. 38 is a perspective view of an alternate dressing bar 700 in accordance with an embodiment of the present invention. A plurality of hydrostatic ports 702 surround the plurality of active surfaces 704A-704G (“704”) on the dressing bar 700. The plurality of hydrostatic ports 702 reduce the flow per port and compensate for the incoming flow variations. The configuration of the ports 702 around the active surfaces 704 averages the response of the dressing bar 700 to variations in micrometer-scale and millimeter-scale topography of the substrate. In essence, the dressing bar 700 acts as a mechanical filter reducing clearance variations due to changes in the topography of the substrate. Manufacturing tolerances and variations in the dressing bar 700 are also averaged and randomized. This leads to less spacing variations. Flow variation causes a proportional change of spacing at the leading edge 706 and the trailing edge 708, serving to maintain the pitch or attitude of the dressing bar 700.

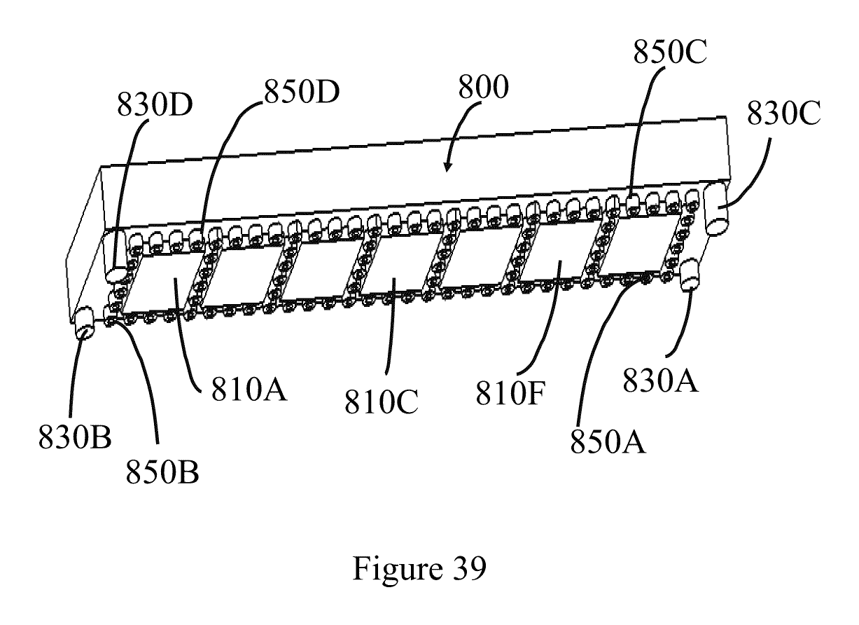

FIG. 39 is a perspective view of an alternate dressing bar 800 in accordance with an embodiment of the present invention. A plurality of hydrostatic ports 850A, 850B, 850C, 850D are connected to 4 independent pressure controllers. A series of leading edge pads 830C and 830D and a series of trailing edge pads 830A and 830B are fabricated onto the corners of the dressing bar. The design causes a topography averaging attained by using a very large number of hydrostatic port. The effect of such large number of ports causes an averaging effect which is very desirable to filter out the substrate topography. A contact detection method is disclosed in an embodiment of the present invention. As the pressure is reduced for example in the hydrostatic ports 850A the pad 830A starts contacting the lapping plate causing a signal to be generated between the lapping plate and the bar. This process can be repeated at all the corners equating the inlet pressure to the spacing at each corner to the corner pad height such inlet pressure is referred to as contact inlet pressure. Once the contact pressure at each corner is established a slight increase in the inlet pressure at each corner causes the dressing bar to clear the lapping plate or substrate. The leading edge pads as depicted by 830C and 830D are higher than the trailing edge pads as depicted by 830A and 830B causing a natural pitch of the dressing bar for effective abrasive particle embedding.

A dressing bar assembly for embedding abrasive particles into a surface of a substrate, includes a support structure, a gimbal assembly connecting a dressing bar to the support structure, a preload mechanism for biasing an active surface on the dressing bar toward the substrate, and at least one fluid bearing for generating a lift between the active surface of the dressing bar and the substrate while the active surface applies a downward force sufficient to embed the abrasive particles into the surface. The gimbal assembly permits displacement of the dressing bar in at least a pitch axis and a roll axis. The fluid bearing can be a hydrodynamic bearing or a hydrostatic bearing. In one embodiment, the hydrostatic fluid bearing includes a pressurized gas port that delivers pressurized gas to pressure ports on the dressing bar. The hydrostatic fluid bearing can also include a gas conduit that extends across the gimbal assembly. The gas conduit delivers pressurized gas to pressure ports on the dressing bar. The dressing bar assembly can also include an actuator located between the dressing bar and the support structure. In some embodiments, a plurality of actuators are located at an interface between the hydrostatic bearing mechanism and the dressing bar.

A dressing bar includes at least one active surface. The dressing bar has a leading edge at one end of the active surface and a trailing edge at the other end of the leading surface. The dressing bar includes a first pressure generating surface portion located generally along a leading edge of the dressing bar; and a second pressure generating surface located generally along a trailing edge of the dressing bar. In one embodiment, the dressing bar includes a plurality of discrete active surfaces on the pressure generating surface on the dressing bar. In another embodiment, the dressing bar includes a plurality of pressure ports located generally along a leading edge of the dressing bar. In another embodiment, the dressing bar includes a plurality of pressure ports located generally along a trailing edge of the dressing bar. In yet another embodiment, the dressing bar assembly includes a plurality of discrete active surfaces on the dressing bar having a plurality of pressure ports substantially surrounding at least one of the active surfaces. In another embodiment, the pressure ports surround a plurality of the active surface portions. In one embodiment, the active surface of the dressing bar includes a surface area greater than a cross-sectional area of the dressing bar measured parallel to the surface of the substrate. In still another embodiment, the active surface includes a taper at a leading edge configured to progressively embed the abrasive particles into the substrate. In another embodiment, the active surface comprises a generally circular structure having a plurality of grooves therein. The taper is located around a perimeter edge of the circular structure. In yet another embodiment, the dressing bar includes a plurality of spacer pads. The spacer pads have a height generally corresponding to a target or selected distance that the embedded abrasive particles extend beyond the surface of the substrate.

An abrasive article includes a substantially flat substrate, and particles embedded into at the substantially flat substrate at a substantially uniform distance above the substrate. The substantially uniform distance varies in a range of 1 to 5 percent of the nominal height of the protruding abrasives. In some embodiments, the abrasive article contains concentrically and circumferentially spaced rings of embedded particles. In still other embodiments, the substrate of the abrasive article further includes a soft layer of plastically deformable material for accepting the abrasive particles.

A dressing bar assembly for embedding abrasive particles into a substrate to make an abrasive article includes a support structure, and a dressing bar supported by the support structure, the dressing bar including a taper at a leading edge. In one embodiment, the taper angle is less than 10 milli radians. In one embodiment, the dressing bar assembly is rectangular in shape. The dressing bar includes a flat region adjacent to the taper, and the flat region includes a plurality of grooves. In another embodiment the dressing bar is a substantially circular structure and the taper is located around a perimeter edge thereof. In either the circular or the rectangular embodiment, the dressing bar can include a plurality of spacer pads located on the flat region of the dresser bar. As set forth above, the dressing bar is adapted to force abrasive particles into a substrate as the dressing bar passes over the substrate. The spacer pad or pads located on the flat region of the dressing bar have a selected height corresponding to a selected distance that the abrasive particles extend above the substrate after being embedded into the substrate. The dressing bar assembly can also include a gimbal assembly connecting a dressing bar to the support structure. The gimbal assembly applies a preload to the dressing bar. The dressing bar assembly can also include a hydrostatic bearing assembly which in turn includes a plurality of ports fluidly coupled to a source of compressed air. The ports are oriented toward the substrate to maintain a hydrostatic fluid bearing between the dressing bar assembly and the substrate. Where a range of values is provided, it is understood that each intervening value, to the tenth of the unit of the lower limit unless the context clearly dictates otherwise, between the upper and lower limit of that range and any other stated or intervening value in that stated range is encompassed within the inventions. The upper and lower limits of these smaller ranges which may independently be included in the smaller ranges is also encompassed within the inventions, subject to any specifically excluded limit in the stated range. Where the stated range includes one or both of the limits, ranges excluding either both of those included limits are also included in the inventions.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

What is claimed is:

1. A dressing bar assembly for embedding abrasive particles into a surface of a substrate, the dressing bar assembly comprising:
a support structure;
a gimbal assembly connecting a dressing bar to the support structure, the gimbal assembly permitting displacement of the dressing bar in at least pitch and roll;
a preload mechanism for biasing an active surface on the dressing bar toward the substrate; and
at least one fluid bearings for generating a lift between the active surface of the dressing bar and the substrate while the active surface applies a downward force sufficient to embed the abrasive particles into the surface.

2. The dressing bar assembly of claim 1 wherein the fluid bearing is a hydrodynamic bearing.

3. The dressing bar assembly of claim 1 wherein the fluid bearing is a hydrostatic bearing.

4. The dressing bar assembly of claim 3 wherein the dressing bar has at least one port therein, the port for delivering a fluid to the active surface of the dressing bar, the fluid used in forming a hydrostatic fluid bearing.

5. The dressing bar assembly of claim 4 further comprising a fluid conduit in fluid communication with the port, the fluid conduit delivering a fluid to the at least one port on the dressing bar.

6. The dressing bar assembly of claim 5 further comprising a plurality of actuators located at an interface between a hydrostatic bearing mechanism that includes the fluid conduit and the dressing bar.

7. The dressing bar assembly of claim 1 further comprising at least one actuator positioned between the dressing bar and the support structure.

8. A dressing bar comprising:
at least one active surface on the dressing bar;
at least one pressure generating surface located generally along a leading edge of the dressing bar; and
at least one pressure generating surface located generally along a trailing edge of the dressing bar.

9. A dressing bar of claim 8 comprising:
a plurality of discrete active surfaces on the pressure generating surface on the dressing bar;
a plurality of pressure ports located generally along a leading edge of the dressing bar; and
a plurality of pressure ports located generally along a trailing edge of the dressing bar.

10. The dressing bar of claim 8 comprising:
a plurality of discrete active surfaces on the dressing bar; and
a plurality of pressure ports substantially surrounding at least one of the plurality of active surfaces.

11. The dressing bar of claim 8 wherein the active surface comprises a surface area greater than a cross-sectional area of the dressing bar measured parallel to the surface of a substrate over which the dressing bar is adapted to pass.

12. The dressing bar of claim 6 wherein the at least one active surface comprises a taper at a leading edge configured to progressively embed the abrasive particles into the substrate.

13. The dressing bar of claim 6 wherein the at least one active surface further comprises a substantially circular structure having a plurality of grooves therein: and
a taper located around a perimeter of the substantially circular structure.

14. The dressing bar of claim 6 further comprising a plurality of spacer pads, the spacer pads attached to the active surface and having a height generally corresponding to a selected height of an embedded abrasive particle above a surface of a substrate.

15. An abrasive article comprising:
a substantially flat substrate;
particles embedded into at the substantially flat substrate at a substantially uniform distance above the substrate, the substantially uniform distance varying in a range of 1 to 5 percent of nominal protruding height of the particles.

16. The abrasive article of claim 15 contains concentrically and circumferentially spaced rings of embedded particles.

17. The abrasive article of claim 15 wherein the substrate further comprises a soft layer of plastically deformable material for accepting the abrasive particles.

18. A dressing bar assembly for embedding abrasive particles into a substrate to make an abrasive article, the dressing bar assembly comprising:
a support structure; and
a dressing bar supported by the support structure, the dressing bar including a taper at a leading edge.

19. The dressing bar assembly of claim 18 has a taper angle of less than 10 milli radians.

20. The dressing bar assembly of claim 18 wherein the dressing bar comprises a generally circular structure and the taper is located around a perimeter edge thereof.

21. The dressing bar assembly of claim 18 wherein the dressing bar comprises a flat region adjacent to the taper, the flat region including a plurality of grooves therein.

22. The dressing bar assembly of claim 18 wherein the dressing bar is adapted to force abrasive particles into a substrate as the dressing bar passes over the substrate, the dressing bar assembly further comprising a plurality of spacer pads located on a flat region of the dressing bar, the spacer pads having a selected height corresponding to a selected distance that the abrasive particles extend above the substrate after being embedded into the substrate.

23. The dressing bar assembly of claim 18 further comprising a plurality of spacer pads located on a flat region of the dressing bar, the spacer pads having a selected height.

24. The dressing bar assembly of claim 18 comprising a gimbal assembly connecting a dressing bar to the support structure, the gimbal assembly applying a preload to the dressing bar.

25. The dressing bar assembly of claim 18 comprising a hydrostatic bearing assembly including a plurality of ports fluidly coupled to a source of compress air, the ports oriented toward the substrate to maintain a hydrostatic fluid bearing between the dressing bar assembly and the substrate.
